(19) United States
(12) Patent Application Publication
(10) Pub. No.: US 2025/0014418 A1
(43) Pub. Date: Jan. 9, 2025

(54) SYSTEM AND METHOD FOR PROVIDING PROMOTIONAL GAME

(71) Applicant: VEGAS VAULT SYSTEMS LLC, Las Vegas, NV (US)

(72) Inventors: Michael Campagno, Las Vegas, NV (US); Timothy J. Brooks, Henderson, NV (US); Ricardo Nava-Gonzalez, Las Vegas, NV (US); Jason Reek, Henderson, NV (US); Courtney Garland, Henderson, NV (US)

(73) Assignee: VEGAS VAULT SYSTEMS LLC, Las Vegas, NV (US)

(21) Appl. No.: 18/755,141

(22) Filed: Jun. 26, 2024

Related U.S. Application Data
(60) Provisional application No. 63/610,066, filed on Dec. 14, 2023.
(60) Provisional application No. 63/510,731, filed on Jun. 28, 2023.

(51) Int. Cl. G07F 17/32

(52) U.S. Cl. CPC G07F 17/3225

(57) ABSTRACT

A method and a system provide a promotional game over a plurality of gaming locations. The promotional game is associated with a vault including a bonus prize and a secret combination of discrete elements. A player may be provided a voucher to participate in the promotional game. An input device is provided to be presented to the player, wherein the player inputs a guess at the secret combination. The player guess at the secret combination is then received through the input device and a determination is won as to whether the bonus prize is won based on the secret combination, the player guess, and a matching criteria associated with the secret combination.

### CROSS REFERENCE TO RELATED APPLICATIONS

This application claims priority to U.S. Provisional Patent Application Ser. No. 63/510,731 filed on Jun. 28, 2023 (Attorney Docket VEGASVAULT-P0001P) and U.S. 63/610,066 filed on Dec. 14, 2023 (Attorney DcVEGASVAULT-P0002P), the entire disclosures of which are hereby incorporated by reference and relied upon.

### FIELD OF THE INVENTION

This invention relates generally to providing a promotional game and more particularly to a method and system for promotional game of that offers prizes.

### BACKGROUND OF THE INVENTION

Games of chance have been enjoyed by people for thousands of years and have especially grown in popularity over the past few decades. The growth of the gaming industry in places such as Las Vegas and Atlantic City and development of large casinos and resorts have helped attract tourists from all over the world. As in most industries, however, the gaming industry has seen fierce competition amongst the casinos to attract customers. This has led many of the larger casinos to provide a wide range of entertainment attractions, such as concerts, magic shows, and even theme parks, in order to draw players to their gaming locations.

One marketing method used by casinos to draw players is by providing promotional games such as progressive jackpots in conjunction with their casino games that allow any player, even those playing on low-wager slot machines, to win large amounts of money. Players involved in games of wagering often enjoy playing the games with relatively simple rules with a chance of winning very large cash prizes. One such promotional game, for example, that has been implemented in some casinos is a game of wheel of fortune, where a player playing a game of video poker or alike can participate in the promotional game by spinning a wheel, according to which the player may win additional bonus prizes.

In many instances, the bonus prizes are progressive jackpots, where a percentage of every player's wager is contributed to the bonus prize. Although many players are attracted to such games because of the chance of winning a large prize, many others find objectionable having to contribute to a jackpot that they have little chances of winning. Accordingly, in many casinos and taverns, the owners pay the bonus prize purely as an incentive to players, without seeking direct player contribution to the bonus prize.

A problem with this promotion method, however, is that large casinos can afford to pay out large cash bonus prizes, leaving smaller taverns and casinos unable to compete. For example, while larger bonus prizes exceeding $50,000 are being paid in many of the large casinos in Las Vegas, most small taverns in Nevada cannot afford to pay bonus prizes larger than $1,000. As a result, smaller taverns and casinos may be losing their local customers to large casinos. Accordingly, there is a need for a gaming system and method that would enable smaller casinos to payout large bonus prizes in order to compete with the larger casinos in attracting players.

The present invention is aimed at one or more of the problems identified above.

### BRIEF SUMMARY OF THE INVENTION

In order solve the problems associated with the conventional gaming promotion methods, embodiments of present invention comprise a gaming system and method for providing a promotional game.

In an exemplary embodiment, there is provided a method for providing a promotional game in conjunction with a wagering game over a plurality of gaming locations and/or with other types of transactions. The promotional game is associated with a vault comprising a bonus prize and a secret combination of discrete elements. The method may: qualifying a player to participate in the promotional game; providing an input device to be presented to the player, wherein the player inputs a guess at the secret combination; receiving the player guess at the secret combination through the input device; and determining if the bonus prize is won based on the secret combination, the player guess, and a matching criteria associated with the secret combination.

In an further embodiment of the invention, the player is qualified to participate in the promotional game if the player meets a minimum number of player tracking points and an external triggering event occurs. In an exemplary embodiment, the input device may be activated for entry of one guess at the secret combination and deactivated after receiving the player guess at the secret combination. In an exemplary embodiment, an element of the secret combination is revealed periodically to increase the probability of satisfaction of the matching criteria.

In one embodiment of the invention, an amount of the promotional prize may increase periodically and be reset to an initial value after the promotional prize is won. The amount of the promotional prize may be increased by a predetermined amount at predetermined time periods, where the predetermined time periods include at least one of daily, weekly, or monthly, and the predetermined amount includes at least one of five percent, ten percent, or twenty percent of the initial value.

In an exemplary embodiment, the matching criteria is defined in terms of a number of elements of the secret combination that must match the player guess or an order in which the elements of the secret combination must match the player guess. In an exemplary embodiment, the matching criteria may include correctly guessing every element of the secret combination in sequence, correctly guessing every element of the secret combination in any order, correctly guessing a portion of the secret combination in sequence, or correctly guessing a portion of the secret combination in any order.

In a further embodiment of the invention, the prize includes a first prize being associated with a first matching criteria and a second prize being associated with a second matching criteria. The second prize may include a smaller amount than the larger prize and the second matching criteria may have a higher probability of satisfaction than the first matching criteria. In an exemplary embodiment, both the first and the second prizes are reset if the first prize is won based on the first matching criteria, but only the second prize is reset if the second prize is won based on the second matching criteria.

According to an exemplary embodiment of the invention, the promotional game is financed or funded separately from the underlying wagering game(s) or transaction.

According to another aspect of the present invention, a gaming system for may provide a promotional game of chance in conjunction with a plurality of base wagering games over a plurality of gaming locations, the promotional game is associated with a vault comprising a bonus prize and a secret combination of discrete elements, the system including: a central server system coupled to a plurality of local computers at the plurality of gaming locations, each of the plurality of local computers being coupled to a plurality of game stations within the respective gaming location and being adapted to qualify a player to participate in the promotional game upon the player meeting at least one qualifying criterion; and a plurality of input devices, each provided within one of the gaming locations, each input device being coupled to the central server system through a network and being adapted to receive a player guess at the secret combination from the player. The central server system determines if the bonus prize is won based on the secret combination, the player guess, and a matching criteria associated with the secret combination.

In an exemplary embodiment, the system further includes a plurality of output interfaces provided within the gaming locations, each output device being coupled to the central server system and being adapted to display at least one of a machine ID or a machine location of the game station on which a player qualifies to participate in the promotional game. The input device is activated for one guess at the secret combination and again deactivated after receipt of the player guess at the secret combination from the player. In an exemplary embodiment, the input device includes a portable pad adapted to be presented to the player to input the player guess at the secret combination.

In an exemplary embodiment, the system also includes a plurality of display screens, each provided on one of plurality of game stations, the display screen being adapted to display at least one of information about the promotional game, a current bonus prize amount, or information about the secret combination.

In a first aspect of the present invention, a networked computer system for providing a promotional game to a plurality of users is provided. The promotional game includes one or more prizes to be awarded to the plurality of users in response to successful guessing of a predetermined vault combination. The vault combination includes a predetermined number of combination locations or elements. The networked computer system includes a central server system, a database, and a local computing device. The central server system is configured to be connected to a plurality of gaming machines by a network and to a player tracking system. The player tracking system is configured to monitor game play and/or other activity of each of the plurality of players and to assign player points to each player as a function thereof. The database is configured to store a player account associated with each of the plurality of players. Each player account includes a number of player points associated with an associated player. The local computing device is connected to the central server system and includes a display device and an input device.

The central server system configured to perform the steps of: providing one of the players a voucher in response to (1) the one of the players accruing a predetermined number of player points in the associated player account, or (2) occurrence of an external triggering event, and allowing the one of the players to redeem the voucher at the local computer device. In response to redemption of the voucher, the local computer device is configured to:
(a) cause display, by the display device, of a virtual representation of the vault combination, wherein each of the predetermined number of combination locations is empty,
(b) cause display, by the display device, of a virtual representation of a plurality possible values associated with the predetermined number of combination locations,
(c) allow the one of the players to select one of the plurality of possible values from the virtual representation of a plurality of possible values, and,
(d) cause display, by the display device, of the virtual representation of the vault combination, with the selected one of the plurality of possible values being shown in one of the combination locations.

Steps (b)-(d) are repeated until all combination locations have a selected one of the plurality of possible values. The selected ones of the plurality of possible values comprise a guess of the one of the players.

The central server system is further configured to perform the steps of comparing the guess of the one of the players with the predetermined combination and awarding the one of the players a prize as a function of the comparison between the guess of the one of the players with the predetermined combination.

In a second aspect of the present invention, a computer based method, implemented by a networked computer system, for providing a promotional game to a plurality of users, is provided. The promotional game includes one or more prizes to be awarded to the plurality of users in response to successful guessing of a predetermined vault combination. The vault combination includes a predetermined number of combination locations. The networked computer system includes a central server system, a database, and a local computer device. The central server system is configured to be connected to a plurality of gaming machines by a network. The central server system is coupled to a player tracking system which is configured to monitor game play and/or other activity of each of the plurality of players and to assign player points to each player as a function thereof. The database is configured to store a player account associated with each of the plurality of players. Each player account includes a number of player points associated with an associated player. The local computing device is connected to the central server system and includes a display device and an input device. The computer-based method including the steps of providing one of the players a voucher in response to (1) the one of the players accruing a predetermined number of player points in the associate player account, or (2) occurrence of an external triggering event and allowing the one of the players to redeem the voucher at the local computer device.

In response to redemption of the voucher, the method includes the steps of (a) causing display, by the display device, of a virtual representation of the vault combination, wherein each of the predetermined number of combination locations is empty, (b) causing display, by the display device, of a virtual representation of a plurality possible values associated with the predetermined number of combination locations, (c) allowing the one of the players to select one of the plurality of possible values from the virtual representation of a plurality of possible values, and (d) causing display, by the display device, of the virtual representation of the vault combination, with the selected one of the plurality of possible values being shown in one of the combination locations. Steps (b)-(d) are repeated until all combination locations have a selected one of the plurality of possible values, the selected ones of the plurality of possible values comprising a guess of the one of the players.

The method further includes the steps of (performed by the central server system): comparing the guess of the one of the players with the predetermined combination and awarding the one of the players a prize as a function of the comparison between the guess of the one of the players with the predetermined combination.

In a third aspect of the present invention, a networked computer system for providing a promotional game to a plurality of users is provided. The promotional game includes one or more prizes to be awarded to the plurality of users in response to successful guessing of a predetermined vault combination. The vault combination includes a predetermined number of combination locations or elements. The networked computer system includes a central server system, a database, and a local computing device. The central server system is configured to be connected to a plurality of gaming machines by a network and to a player tracking system. The player tracking system is configured to monitor game play and/or other activity of each of the plurality of players and to assign player points to each player as a function thereof. The database is configured to store a player account associated with each of the plurality of players. Each player account includes a number of player points associated with an associated player. The local computing device is connected to the central server system and includes a display device and an input device.

The central server system configured to perform the steps of: providing one of the players a voucher in response to (1) the one of the players accruing a predetermined number of player points in the associated player account, or (2) occurrence of an external triggering event, and allowing the one of the players to redeem the voucher at the local computer device. In response to redemption of the voucher, the local computer device is configured to:
(a) cause display, by the display device, of a virtual representation of the vault combination, wherein each of the predetermined number of combination locations is empty,
(b) cause display, by the display device, of a virtual representation of a plurality possible values associated with the predetermined number of combination locations,
(c) allow the one of the players to select one of the plurality of possible values from the virtual representation of a plurality of possible values, and,
(d) cause display, by the display device, of the virtual representation of the vault combination, with the selected one of the plurality of possible values being shown in one of the combination locations.

Steps (b)-(d) are repeated until all combination locations have a selected one of the plurality of possible values. The selected ones of the plurality of possible values comprise a guess of the one of the players.

The central server system is further configured to perform the steps of comparing the guess of the one of the players with the predetermined combination and awarding the one of the players a prize as a function of the comparison between the guess of the one of the players with the predetermined combination.

The number of combination locations in the vault combination is m, wherein the prize awarded to the one of the players is (1) a grand prize if the guess of the one of the players matches all values in the vault combination and (2) a consolation prize if the guess of the one of the players matches m−1 values in the vault combination. The one of the players is awarded a predetermined number of drawing tickets in response to the voucher being redeemed and the player being awarded neither the grand prize nor the consolation prize. After each successive week having passed without the grand prize or consolation prize being awarded to one of the players: one of the vault combination location is prepopulated, the grand and consolation prizes are increased, and the predetermined number of drawing tickets are increased. The consolation prize is reset to a consolation base amount after the consolation prize has been awarded to one of the players. The possible values are two digits ranging from 00 to 99. Each player is awarded a predetermined cash prize based on a number of vouchers redeemed by each player. The predetermined cash prize is a function of the number of vouchers redeemed by each player in a week. The voucher provided to one of the players is an electronic voucher if based on player tracking points and is an electronic voucher if based on an external triggering event.

Further objects, features, and advantages of the present invention over the prior art will become apparent from the detailed description of the drawings which follows, when considered with the attached figures.

### BRIEF DESCRIPTION OF THE SEVERAL VIEWS OF THE DRAWINGS

These and other features and advantages of the present invention will become more readily appreciated when considered in connection with the following detailed description and appended drawings.

FIG. 1A is a block diagram of a system for providing a promotional game according to an embodiment of the present invention.

FIG. 1B is an illustration of an exemplary database for use with the system of FIG. 1.

FIG. 1C shows an exemplary block diagram of a system for managing and operating a promotional game throughout a plurality of gaming locations, according to an exemplary embodiment of the present invention.

FIG. 2 depicts a block diagram of the association between a plurality of promoters, vaults, and gaming locations, according to an exemplary embodiment of the invention.

FIG. 3 depicts an alternative embodiment of the present invention, in which each vault is associated with one or more gaming locations.

FIG. 4 depicts a system of operation of a promotional game of chance within a single gaming location, according to an exemplary embodiment of the invention.

FIG. 5 depicts an exemplary association of the various prizes with a secret combination of a vault, according to an embodiment of the invention.

FIG. 6 depicts an exemplary process flow chart associated with a promotional game, according to an embodiment of the invention.

FIG. 7 depicts a second exemplary process flow chart associated with a promotional game.

FIG. 8 depicts a third an exemplary process flow chart associated with a promotional game.

FIGS. 9A-9E show an exemplary embodiment of a secret combination having one element revealed periodically, according to an exemplary embodiment of the invention.

FIG. 10 is a block diagram of a server architecture of an embodiment of the present invention, which may be referred to as the “Vegas Vault” promotional game.

FIG. 11 is a block diagram of database dependencies of the Vegas Vault promotional game embodiment of FIG. 10.

FIG. 12 is a flow diagram of the Vegas Vault promotional game of FIG. 10.

FIG. 13 is a process diagram associated with the Vegas Vault promotional game of FIG. 10.

FIG. 14 is a block diagram of a multi-location implementation of the Vegas Vault promotional game of FIG. 10.

FIGS. 15-26, 27A-27D, 28A-28D, 29A-29D, and 30A-30M are exemplary graphics which may be utilized in a specific implementation of the Vegas Vault promotional game.

FIGS. 31A-31F are exemplary graphics which may be utilized in another specific implementation of the Vegas Vault promotional game.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. While exemplary embodiments are discussed in this description, it should be understood that this is done so for purposes of illustration only. A person of ordinary skill in the art will recognize that other methods and configurations can be adopted without parting from the spirit and scope of the present invention.

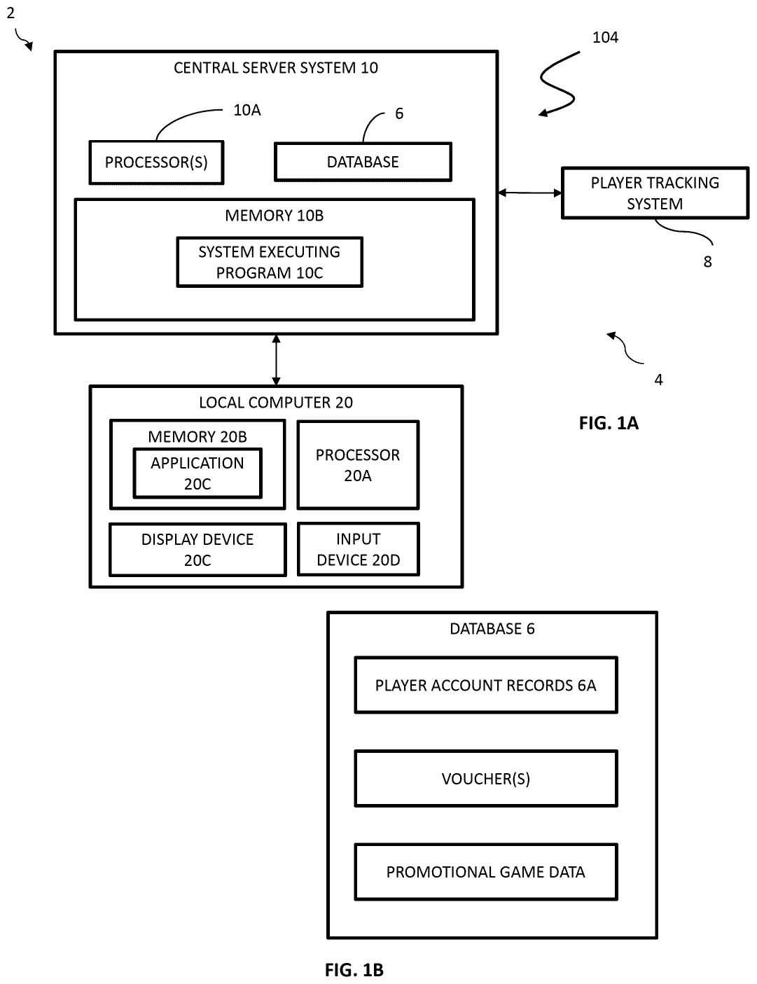

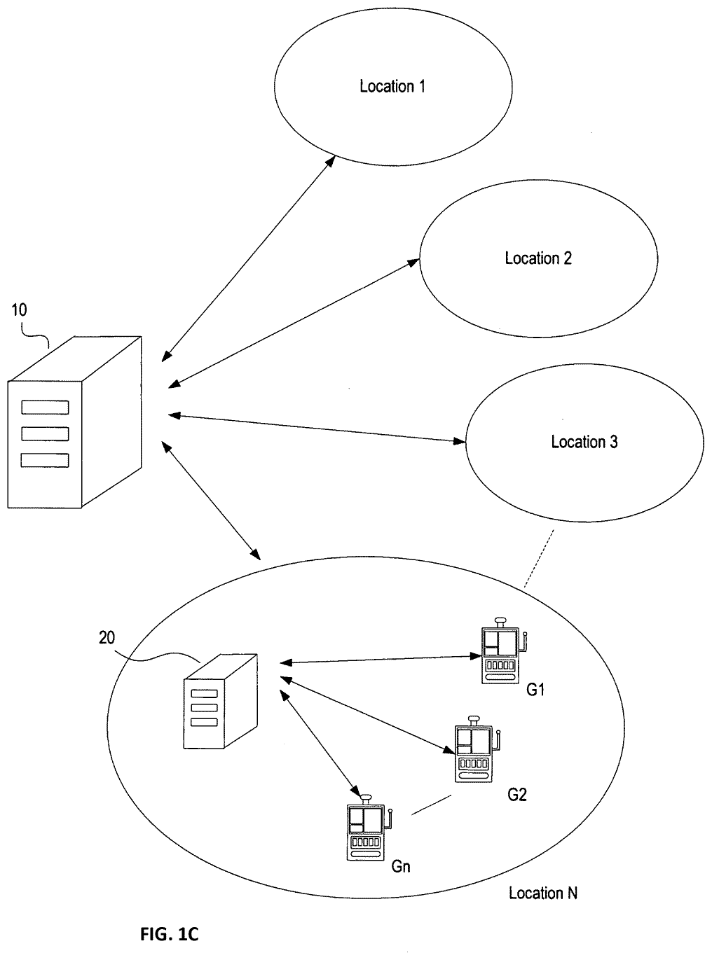

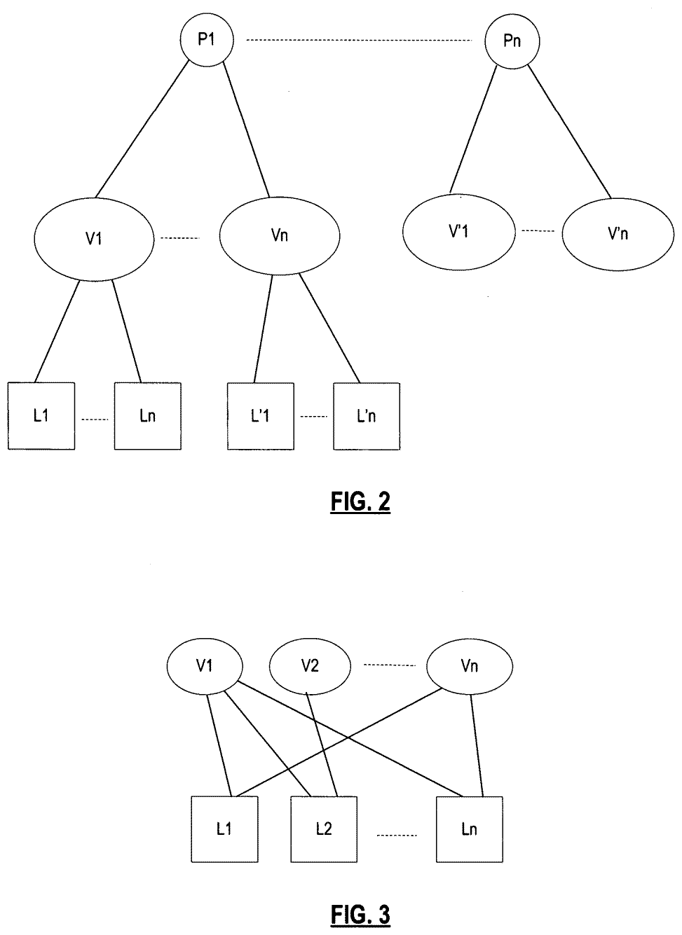

Turning now to the drawings and referring initially to FIG. 1A, there is shown an exemplary system 2 for managing and operating a promotional game over a gaming network 100 throughout a plurality of gaming locations or properties, e.g., casino properties, according to an exemplary embodiment of the present invention. In an exemplary embodiment, the network 100 involves a plurality of gaming locations (1 to N), each including one or more gaming machines and/or transactional machines (for example, point-of-sale machines) (G1 to Gn), and a central server system 10.

A promoter operating the central server system 10 offers the promotional game as an incentives for players to play games provided by the gaming or make purchases at the transactional machines (G1 to Gn) at the gaming locations. Each of the gaming locations (1-N) may also include a local computer 20, which is securely coupled to the central server system 10 through a network 4 such as, for example, the Internet or other network. The central server system 10 operates a promotional game of chance in association with the gaming locations (1 to N). A player attending one of the gaming locations (1 to N) may qualify to participate in the promotional game based on one or more criteria.

In one aspect of the present invention, the promotional game in the form of a vault having a vault combination required to open the vault. Players are provided with one or more guesses at the vault combination. If one of the players is successful at guessing the vault combination, then the vault “opens” and the player is awarded a prize. The vault combination includes a number of vault combination locations. For instance, in one embodiment, the vault combination includes 5 or 6 vault combination locations. Further, each location may be populated with a value selected from a plurality of possible values. In one embodiment, the plurality of possible values are the digits 0 to 9. In another embodiment, each of the plurality of possible values is a two digit numbers from 00 to 99. In other embodiments, the plurality of possible values may numbers, letters, symbols, or any combination thereof. The vault combination may be determined using a random number generator (RNG).

In one embodiment, if the player guesses the full vault combination, then the player is awarded a Grand Prize (see below). However, if the player guesses some, but not all of the elements of the vault combinations, then the player may be awarded a consolation prize. For instance, in one embodiment, if the vault combination includes m locations, then a player may be awarded a consolation prize in response to the player correctly guessing the value in m−1 of the vault locations correctly. In one aspect of the present invention, when a player wins a consolation prize, the consolation prize is reset to its base or seed amount. The Grand Prize will increase. The secret combination is changed, or generated anew using the RNG. As discussed in further detail below, over time, one of the values of the secret combination may be revealed. Thus, the player needs to correctly guess less than the whole secret combination. This results in the secret combination being easier to guess while the Grand Prize increases.

Players may be awarded one guesses of the vault combination in various ways. For instance, players may be awarded a predetermined number of guesses of the vault combination in response to accruing a predetermined number of player tracking points in the player tracking system 8. Alternatively, or in addition, the players may be awarded one or more guesses of the vault combination based on an external triggering event. In one aspect of the present invention, the one or more guesses are awarded to the player in exchange for the associated number of player tracking points. The external triggering event could be a predetermined event within a game played or a transaction, such as a purchase made, on one of the gaming or transactional machines. The accrual/redemption of player tracking points in exchange for the guesses and/or the external triggering event may be referred to generally as a triggering event.

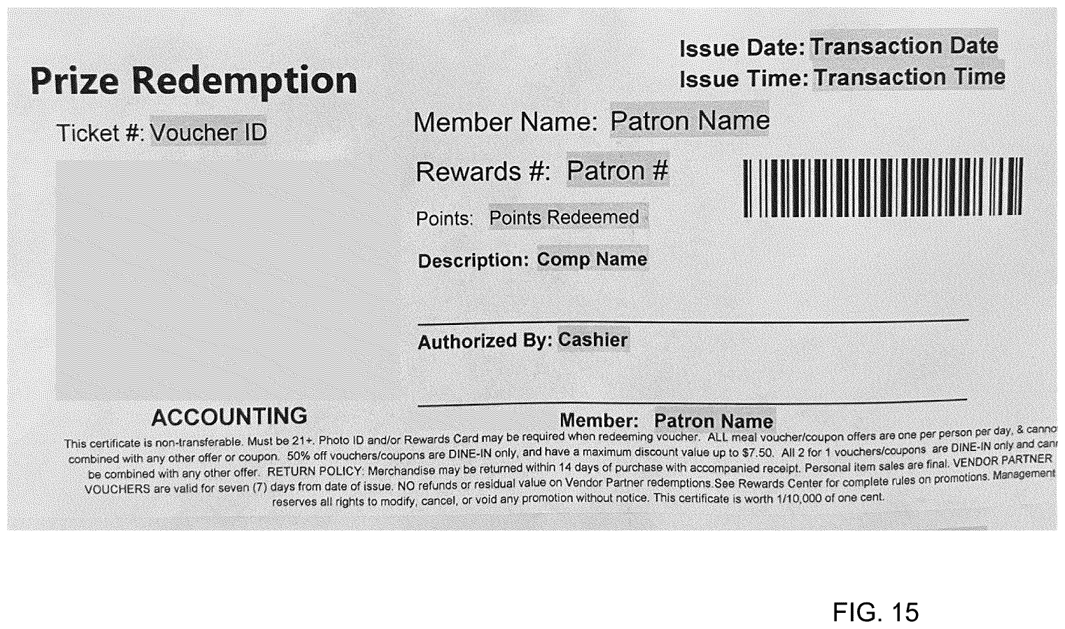

When the system 2 awards a player one or guesses of the vault combination, each guess may be embodied or represented by a voucher. The voucher may be an electronic record of each guess or a physical voucher (see FIG. 15) that may be exchanged at a kiosk or employee station, e.g., the cage at the casino.

In another aspect of the present invention, the promotional game is funded independently of the gaming machines. In other words, the prizes are not funded by the players' wagers or transactions, i.e., purchases, at the gaming or transactional machines. For instance, the promotional game may be funded primarily via a marketing budget.

In another aspect of the present invention, a player may be provided one or more entries into a digital drawing if, for example, the player guesses at the vault combination and does not win either grand prize or the consolation prize. Further, players may be awarded cash prizes based on a number of guesses awarded during predetermined time periods. Further details are provided below.

In the illustrated embodiment, each gaming location may include a player tracking system 8. As is known, the player tracking system 8 may track game play and/or transactions made at the gaming or transactional machines and award players with player tracking points. Generally, the player tracking points may be utilized by the players in various fashions, e.g., be exchanged for goods or services. As discussed in more detail below, the player tracking points may be utilized to qualify for one or more opportunities to play the promotional game. In addition, a player may be afforded or awarded an opportunity to play the promotional game based on a predetermined triggering event within a game played by the player on one of the gaming machines and/or a transactional at one of the transactional machines. As is known, the player tracking system 8 may include a player tracking device (not shown) embedded, or provided within, each gaming machine.

In one embodiment, the promotional game is provided by the central server system 10 which is communication via the application programming interface(s) (API) provided by the provider of the player tracking system 8. In another embodiment, the central server system 10 is part of the player tracking system 8 and the promotional game is provided by the player tracking system 8.

A local computer 20 may be utilized to a play the promotional game and may be implemented by, or within, a computer operated by an employee of the gaming location, a kiosk, may be implemented as the player tracking device embedded in a gaming machine, or may be implemented by a computing device provided, accessed, or owner by the player, such as a cell phone, tablet, personal computer, or laptop computer.

In an exemplary embodiment of the present invention, a promoter may operate the promotional game from a single location without utilizing the central server system 10.

With specific reference to FIG. 1B, in the illustrated embodiment, the system 2 may be implemented, at least partially, on the central server system 10. The central server system 10 may include one or servers and a database 6 managed by the one or more servers. The database 6 stores and maintains various records or data files for use by the system 2. A system memory device 10B stores one or more pieces of software or system execution program(s) which are used by the server(s) and/or other devices for controlling operation of the system 2, central server system 10 and/or other devices of, or associated with, the system 2 or local computer 20. The system execution program(s) comprise algorithms, which when run by the various devices, implement respective functions and/or engines of the system 2.

As discussed above, in the illustrated embodiment, the (system) memory device 10B stores a system execution program including computer instructions. The database 6 is coupled to central server system 10 for storing data records related to a plurality of users of the system. The central server system 10 is coupled to the memory device 10B and the database 6. The central server system 10 includes at least one processor 10A programmed to execute the system execution program to provide the promotional game.

As stated above, in the illustrated embodiment, the system executing program 10C may be stored in the memory device 10B. In some embodiments, the memory device 10B may include non-transitory media, such as a programmable ROM memory device or an optical disk. In other embodiments, the memory device 10B may include a disk drive such as a magnetic hard disk drive and a solid-state disk drive.

With reference to FIG. 1B, the database 6 may be used to store player account records 6A, voucher records 6B, which when awarded are assigned to one of the players, Each player account record 6A is associated with one of the player. Each player account may include information related to the user, as well as player tracking data, and vouchers assigned or awarded to the player.

Applications may be downloaded and stored and/or run on the local computer 20. The application may be stored in memory 20B associated with the local computer 20 and may be run or executed by a processor 20A of the local device.

The server system 106 is coupled to the memory device 112, the database 116, and the user applications 124. The server system 106 includes a processor 110 programmed to execute the system execution program 114.

FIG. 2 depicts a block diagram of the association between a plurality of promoters, vaults, and gaming locations, according to an exemplary embodiment of the invention. An exemplary embodiment of the present invention includes one or more promoters (P1-Pn), each promoter managing and operating one or more promotional games of chance. Each promotional game of chance is associated with a vault (V1-Vn). As defined herein, a vault comprises one or more prizes, for example, a cash prize. A vault can be opened for accessing the one or more cash prizes by winning a corresponding promotional game. For example, the vault might correspond to a promotional game of a secret combination, where a player can open the vault and win one or more of the vault prizes by correctly guessing all or a portion of the secret combination. In an exemplary embodiment, each vault (V1-Vn) is associated with a group of gaming locations (L1-Ln), (L′1-L′n), etc., respectively, and each vault (V1-Vn) is associated with a secret combination that allows a player to open the vault, i.e., to win the promotional game of chance associated with the vault and thereby win the contents of the vault.

FIG. 3 depicts an alternative embodiment of the present invention, in which each vault (V1-Vn) is associated with one or more gaming locations (L1-Ln). Each gaming location (L1-Ln), in turn, is associated with one or more vaults (V1-Vn). In this embodiment, the gaming locations may operate multiple promotional games of chance in conjunction with multiple vaults (V1-Vn). For example, as depicted in FIG. 3, location L2 operates two promotional games of chance associated with V1 and V2.

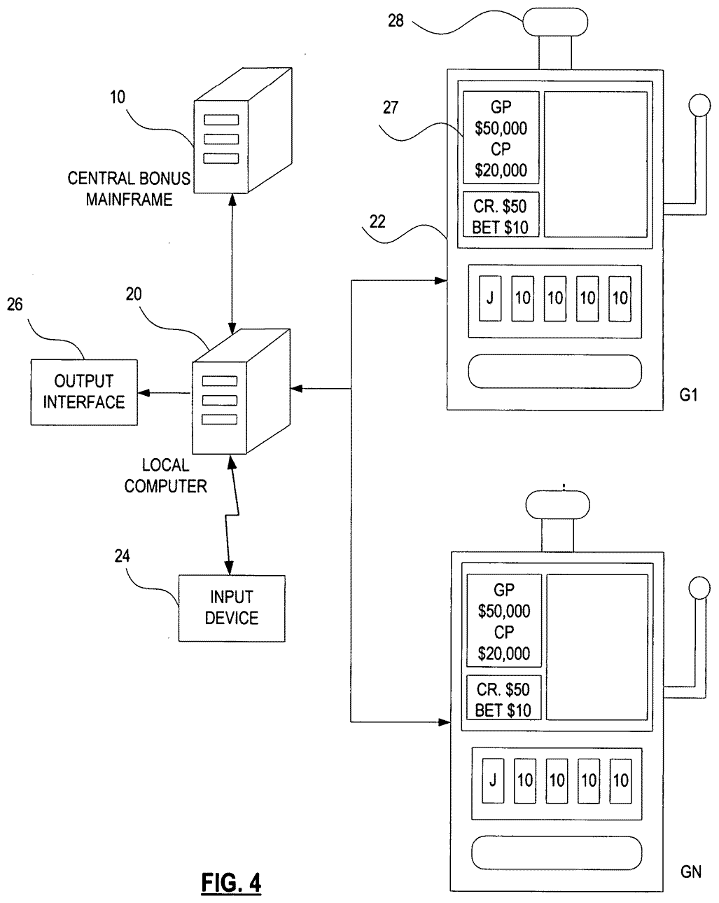

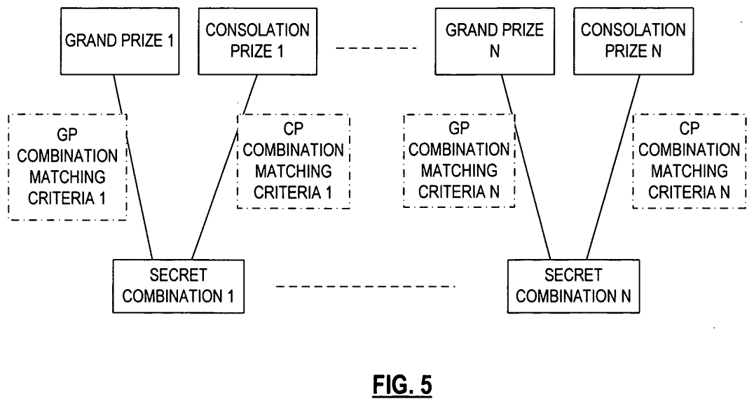

FIG. 4 depicts a system of operation of a promotional game of chance within a single gaming location, according to an exemplary embodiment of the invention. In an exemplary embodiment, the local computer 20 within a gaming location is connected to one or more game stations 22, an information input device 24, and an information output device 26. The game station 22 operates or provides a game that the player may play. In one exemplary embodiment, the game station 22 is a machine running a game of video poker. However, game stations running various games of chance such as, e.g., classic 777 Heaven, Magic Wheel, Wheel of Fortune, etc. may also be used in embodiments of the invention. Further, the games may include live casino games, such as a live game of blackjack or poker, allowing a player to qualify for the promotional game upon the player meeting a certain winning criteria that may game independent.

In an exemplary embodiment, the input device 24 may be a keyboard or a pad containing digits, numbers, or other symbols that can be entered sequentially. The connection between the local computer 20 and the input device 24 may be wired or wireless. The output device 26 may be a printer, a monitor, or any other output device.

According to an embodiment of the invention, a player (or user) may qualify to play the promotional game in response to a triggering event occurring (see above). A triggering event may be defined as accruing a predetermined number of player tracking points (which are exchanged for one or more guesses of the vault combination). A triggering event may also be an external triggering event. An external triggering event may be defined as a certain event, e.g., a winning event or criteria, in a played game on a game station 22. For example, the winning criteria for a game of video poker may be set to a four of a kind. Thus, when a player playing on a base station 22 operating a game of video poker hits a four of a kind, the player becomes eligible to play the promotional game. In some embodiments of the present invention, in addition to meeting the winning criteria, a minimum wager in the base game may be required in order for the player to qualify for the promotional game.

According to one embodiment, the promotional game is associated with a vault that includes at least one cash prize that can be won by correctly guessing a secret combination. A secret combination is uniquely associated with the vault and includes a plurality of elements, e.g., digits, letter, or other symbols. When a player meets the winning criteria on the base game 22 and qualifies to play the promotional game, he is presented with the opportunity to guess the secret combination. In an exemplary embodiment, the secret combination has six elements comprising digits in the range of 0 to 9. The qualified player is presented with an input device for entry of digits 0 through 9. The player can guess the combination by entering the digits one at a time on the input device. If the entered combination matches the secret combination, the player wins a bonus prize from the vault associated with that secret combination.

In some embodiments of the present invention, the input device 24 presented to the player may be a keypad comprising a plurality of digits, letters or symbols. In other embodiments, the input devices may be implemented on or adjacent to the game station, allowing the qualifying player to input the combination directly from the game station.

In one embodiment of the present invention, the vault comprises two types of bonus prizes—a grand prize and a consolation prize. Both the grand prize and the consolation prize start at a minimum prize and are progressively increased as the game continues. The amount of the grand prize is typically higher than the amount of the consolation prize. In one embodiment, the increases are periodic, for example, once a week. In an exemplary embodiment, the grand prize starts at $50,000 and the consolation prize starts at $20,000. Also, in an exemplary embodiment, the grand prize is increased by $10,000 and the consolation prize is increased by $5,000 every week. It should be noted that the grand prize and consolation prize do not have to increase concurrently. One prize could be increased according to one period and the other according to another period. The central server system 10 is responsible for keeping account of the various prizes in the vault. When any of the prizes are won, that prize is reset to its starting value.

In one embodiment of the present invention, as depicted in FIG. 4, the game station 22 comprises a display screen 27 which displays the updated amount of the various bonus prizes. For instance, in the exemplary embodiment discussed above, the display screen 27 displays the amount of the grand prize and the consolation prize. In a further embodiment, the display screen 27 may be configured to display a message to the player upon the player qualifying to play the promotional game, alerting him to wait until he is presented with the input device. In a further embodiment, the display screen 27 may be configured to display a congratulatory message to the player upon the player winning a bonus prize by guessing the correct secret combination.

According to one embodiment of the invention, when a player meets the winning criteria for the base game, the game station 22 notifies the local computer 20 that a player has qualified to participate in the promotional game. The local computer 20 outputs information such as the location or ID of the winning game station to the output interface 26, which may be a printer, a monitor, or other means of outputting the information. An attendant then reviews the information and takes the input device 24 over to the game station matching the location or the ID of the winning game station, where the player inputs his guess at the secret combination on the input device 24. In another embodiment, each game station 22 may comprise an input device (not shown in the figure), allowing the player to input his guess at the secret combination directly on the game station, without the need for an attendant physically presenting the input device to the player.

Still another embodiment of the present invention comprises a siren 28 connected to the game station 22 that sounds upon the player qualifying to play the promotional game. The siren notifies the surrounding crowd, as well as an attendant, that a player has qualified to play the promotional game. The attendant then brings the input device 24 to the game station 22, allowing the player to input his guess at the secret combination on the input device 24. The siren 28 may also be implemented with other embodiments of the present invention to attract or alert the surrounding crowd and the attendant when a player qualifies to play the promotional game.

Referring to FIG. 5, there is depicted an exemplary association of the various bonus prizes with a secret combination of a vault, according to an embodiment of the invention. In an exemplary embodiment, each vault includes at least one bonus prize and at least one secret combination. Each secret combination is associated with one or more bonus prizes. In the exemplary embodiment depicted in FIG. 5, grand prize 1 and consolation prize 1 are associated with secret combination 1, grand prize N and consolation prize N are associated with secret combination N, and so on. For each association of a bonus prize and a secret combination, there is designated a combination matching criteria. The combination matching criteria identifies the circumstances under which the player's guess at the combination constitutes a winning of the bonus prize. For example, in shown in FIG. 5, the GP combination matching criteria 1 could be “entering all six digits correctly in sequential order,” whereas the CP combination matching criteria 1 could be “entering five of the six digits correctly in sequential order.” Another example of the CP combination matching criteria 1 could be “entering all six digits correctly in any order.”

In an embodiment of the present invention, the elements of the combination may be given any order. A player can win the grand prize by correctly guessing every element of the secret combination in a sequential order. Alternatively, a player who fails to guess every element of the secret combination may still win the consolation prize if he correctly guesses a portion of the sequence of the secret combination. For example, in the above exemplary embodiment where the secret combination is six elements comprising digits from 0 to 9, the player may win the grand prize by correctly guessing all 6 elements of the secret combination in correct order. However, even if the player does not guess the right combination of the grand prize, he can still win the consolation prize if he correctly guesses 5 of the 6 elements in correct order.

Returning to FIG. 1A, in one embodiment of the present invention a networked computer system 2 for providing a promotional game to a plurality of users (whom may be players). As discussed above, the promotional game is in the form a vault with a secret vault combination. The players may be awarded one or more guesses of the vault combination. The vault combination includes a plurality of combination locations. Each combination location is populated or assigned a value from a plurality of possible values. In the illustrated embodiment, the networked computer system 2 includes a central server system 10, a database 6, and a local computing device or computer 20. The central server system 10 may be coupled to a player tracking system 8. The player tracking system 8 may be a separate system or the central server system 10 and the player tracking system 8 may be implemented as a single computer system. Generally, the player tracking system 8 may be configured to monitor game play and/or other activity of each of the plurality of players and to assign player points or player tracking points to each player as a function thereof, game play, purchases, and/or other activity.

The database 6 is configured to store a player account (player account records 6A) associated with each of the plurality of players. Each player account may include a number of player points associated with an associated player. The database 6 may also include information related to the vouchers (electronic and/or paper) issued by the system 2. The vouchers may be stored separately from the player account records 6A (and assigned to one of the player accounts) or may be stored directly within each account record. The local computing device 20 is connected to the central server system 10 includes a display device 20D and an input device 20E.

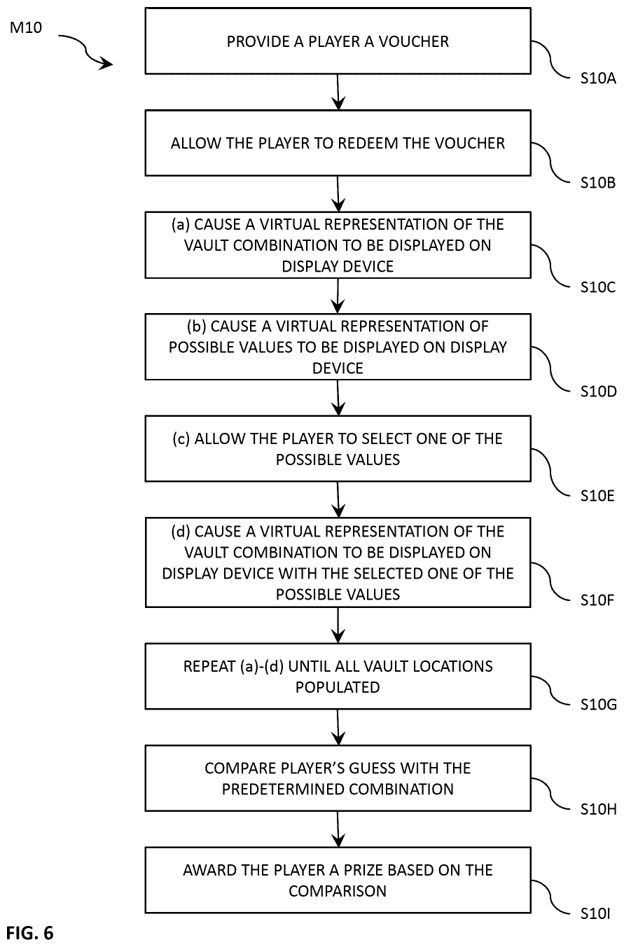

With reference to FIG. 6, in one embodiment a method M30 associated with the promotional game and implemented, at least in part, by the networked computer system 2.

In a first step S10A, the central server system 10 is configured to provide one of the player a voucher (electronic or paper) in response to (1) the one of the players accruing a predetermined number of player points in the associated player account (via the player tracking system 8), or (2) occurrence of an external triggering event (see above). In a second step S10B, the one of the players is allowed to redeem the voucher at the local computer device 20. As discussed above, the local computer device 20 may be a kiosk or computer operated by an employee of the casino or property. The local computer device 20 may also be a player tracking device embedded at a gaming station or a user device associated with the user/player through which the player can redeem a voucher and make a guess of the vault combination.

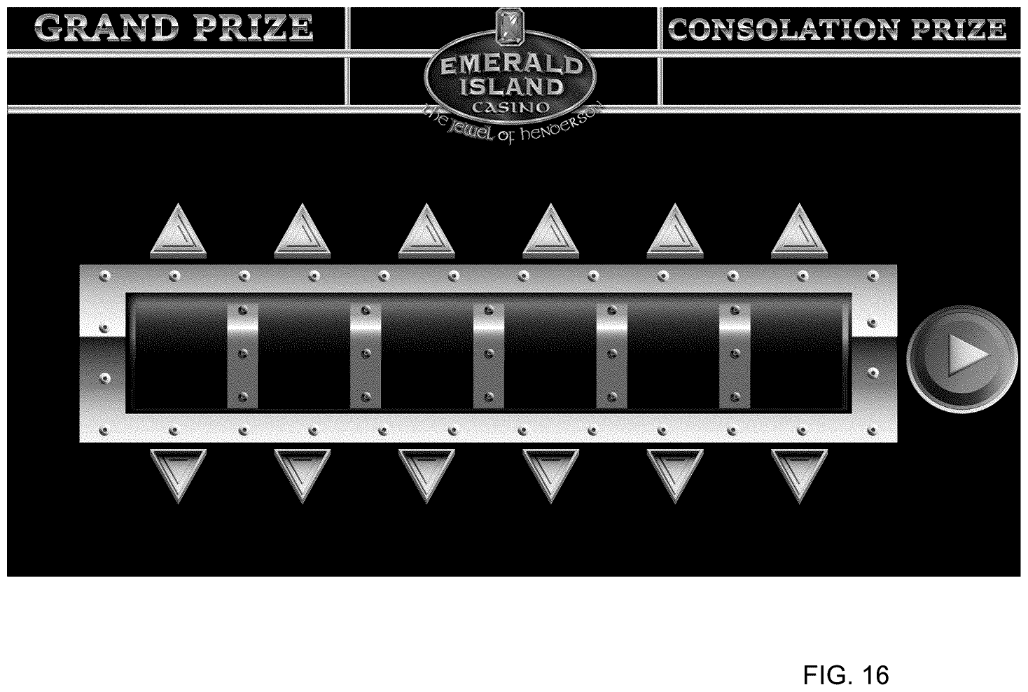

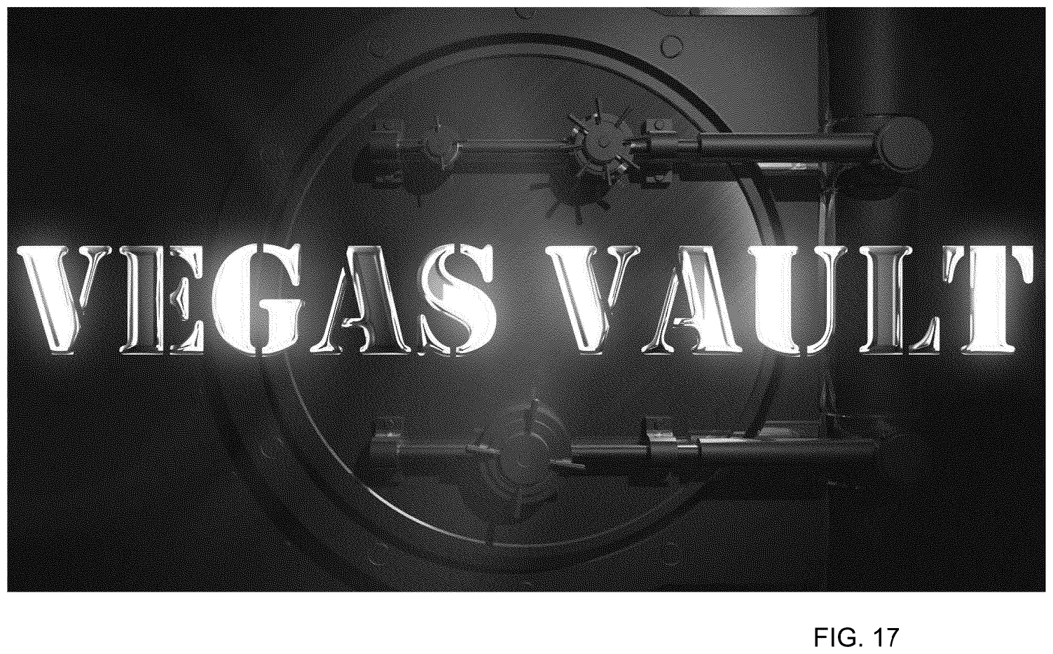

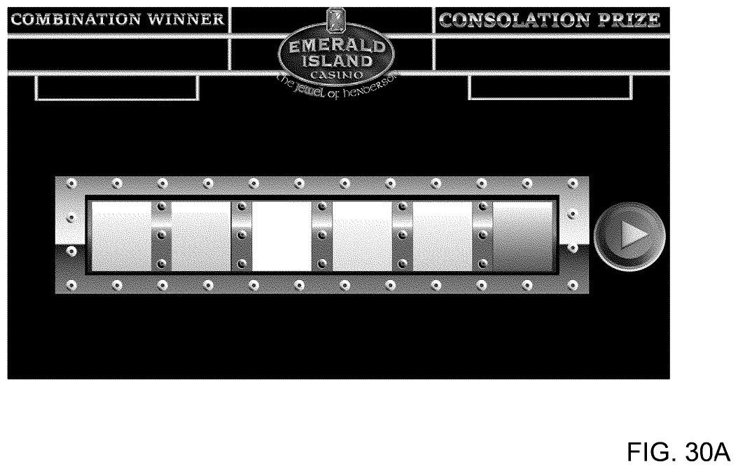

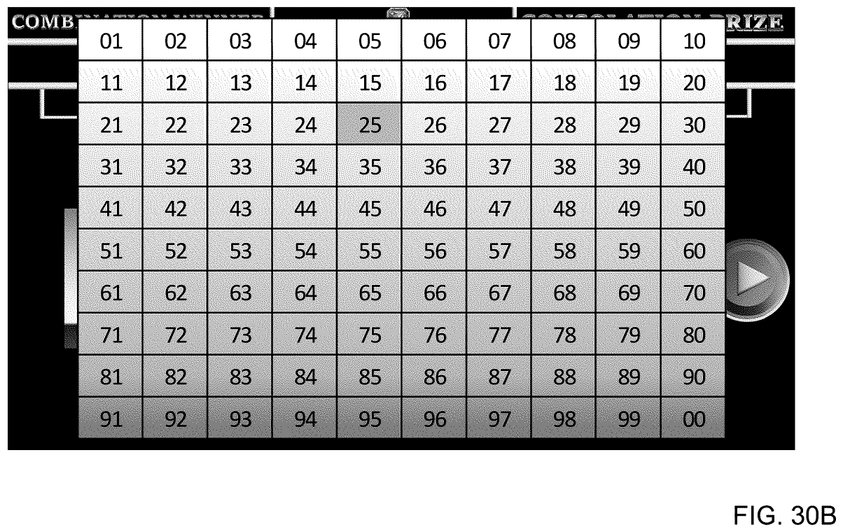

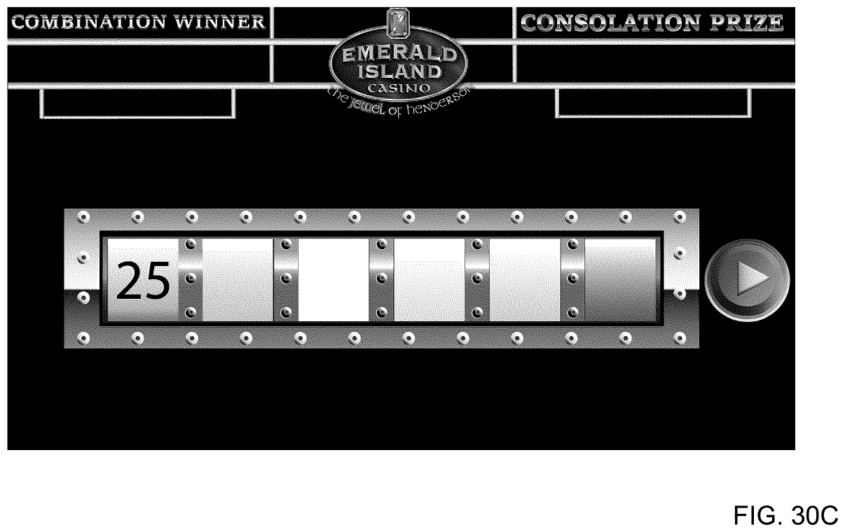

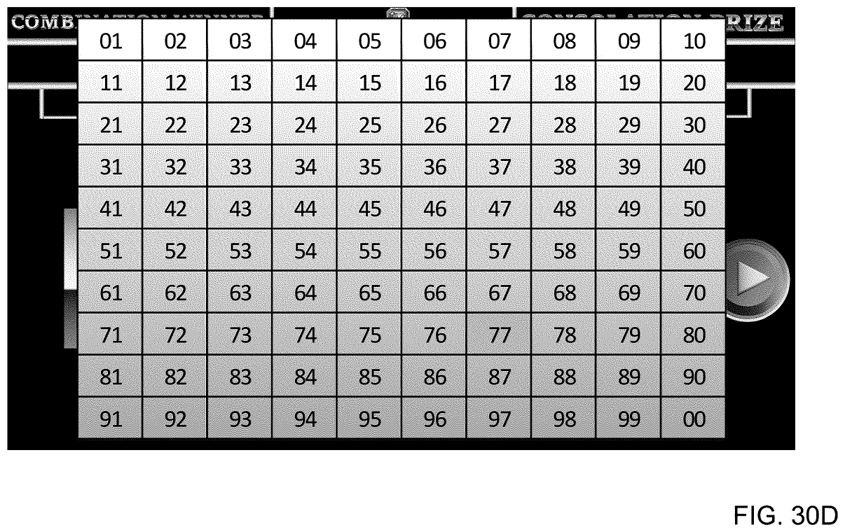

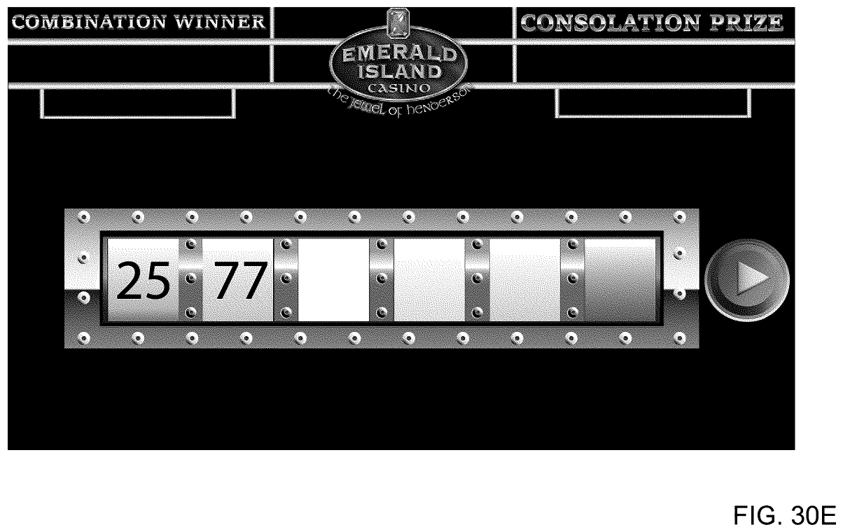

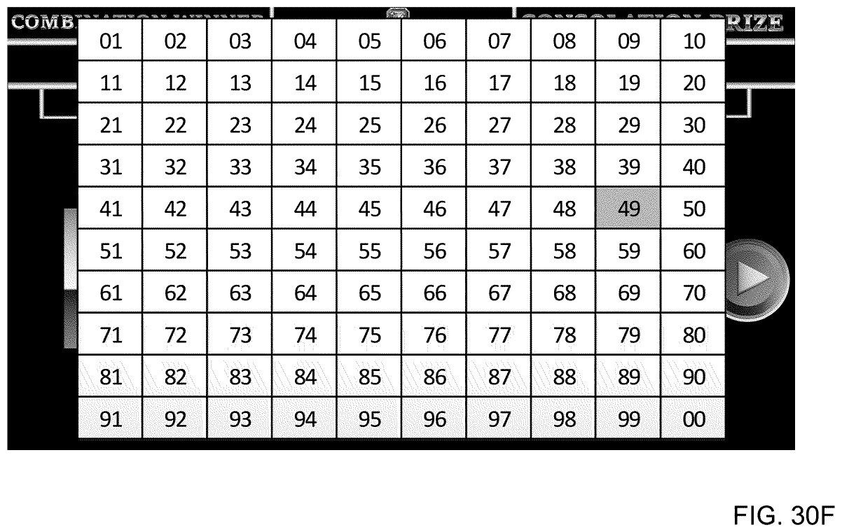

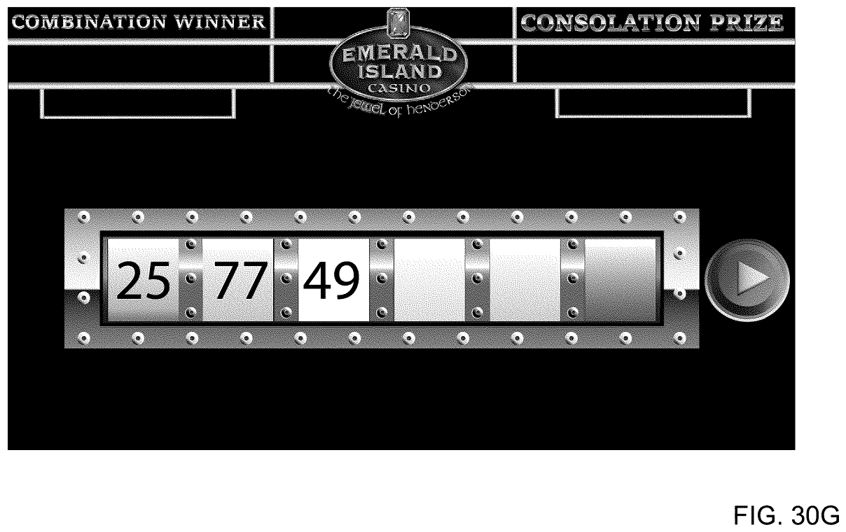

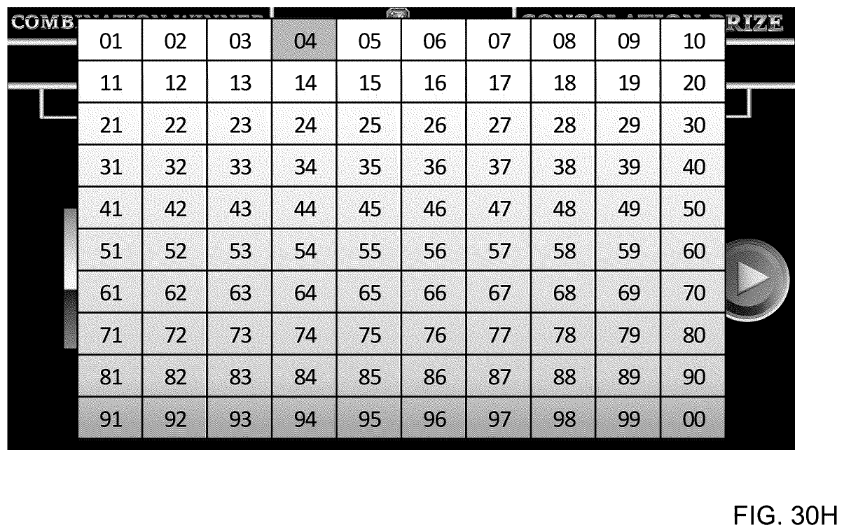

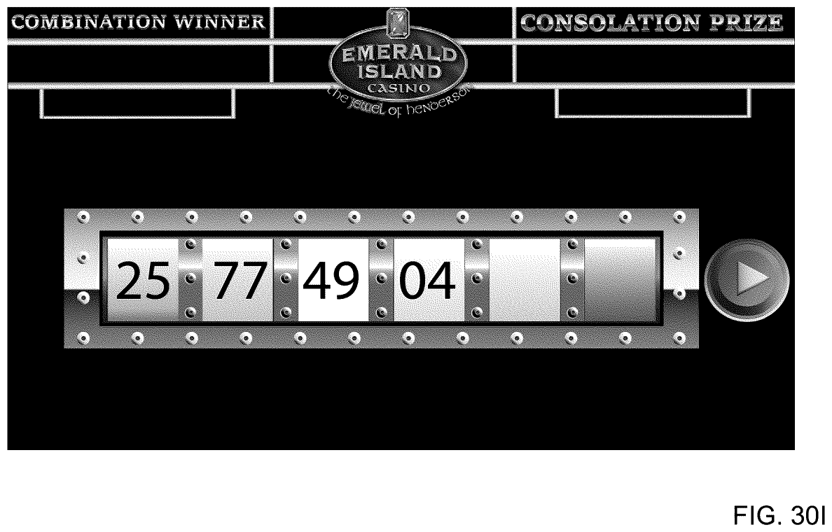

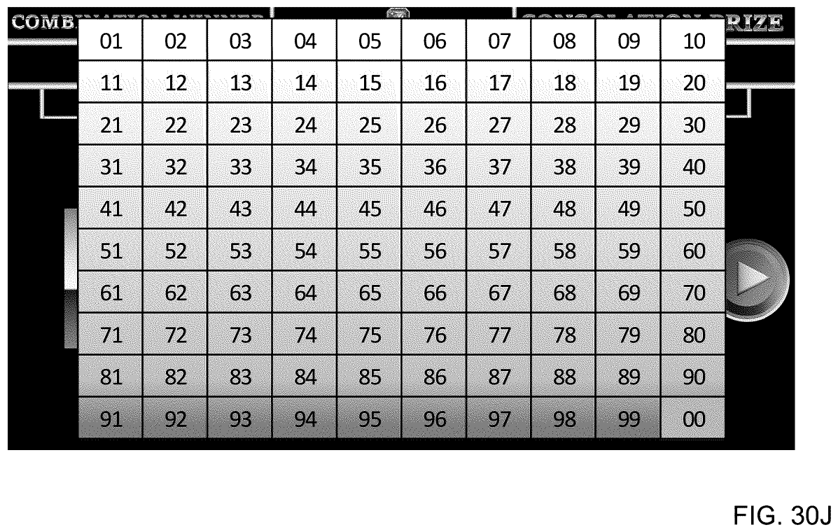

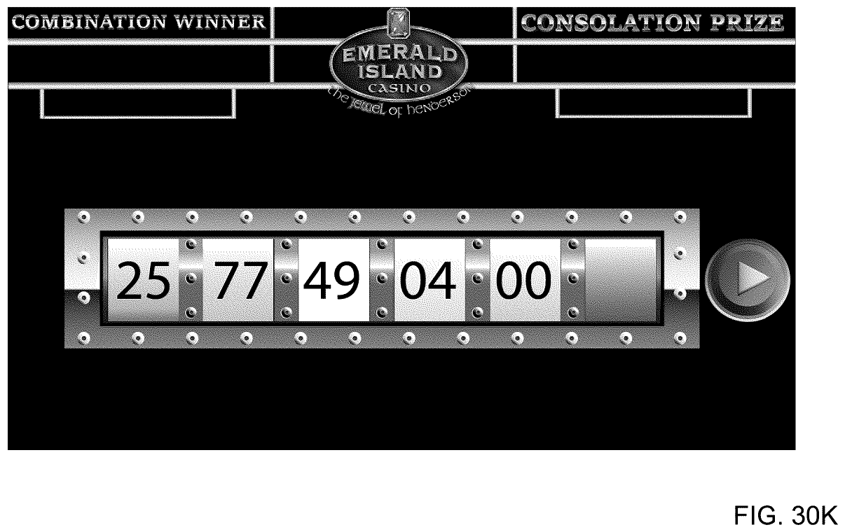

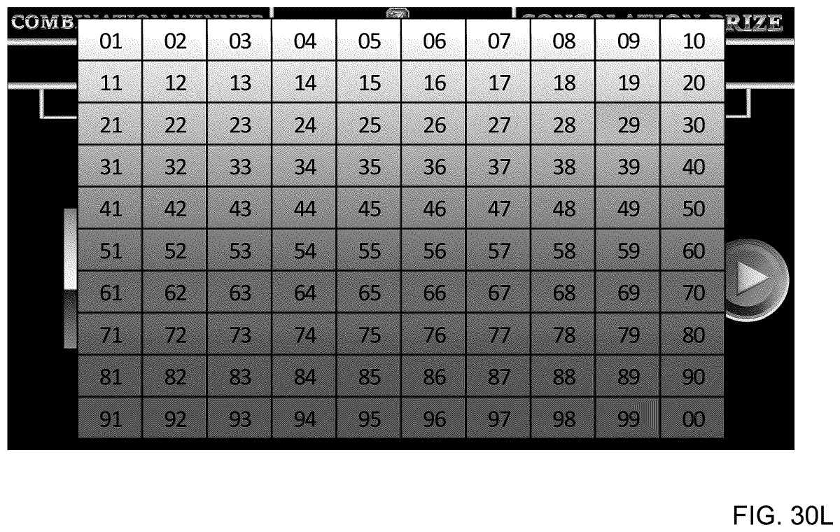

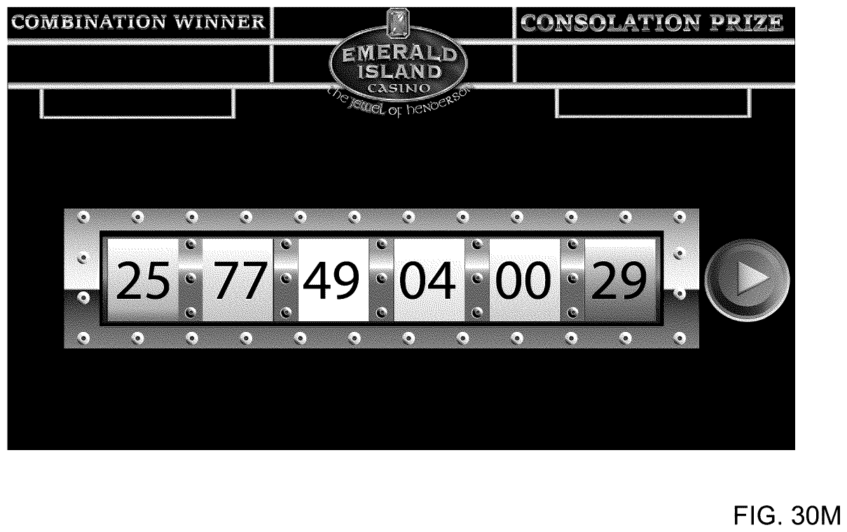

In a third step S10C (“(a)”), the local computer device 20 causes a virtual representation of the vault combination to be displayed on the display device 20C. Initially, each of the predetermined number of combination locations is empty (see for example, FIGS. 16 and 30A).

In a fourth step S10D (“(b)”), the local computer device 20 causes a virtual representation of the possible values for each vault combination location to be displayed on the display device 20C.

In a fifth step S10E, (“(c)”), the player is allowed to select one of the possible values using the input device 20D. In one embodiment, the input device 20D may be a numerical keypad or keyboard. Alternatively, the input device 20D may be a touchscreen device associated with the display device 20C.

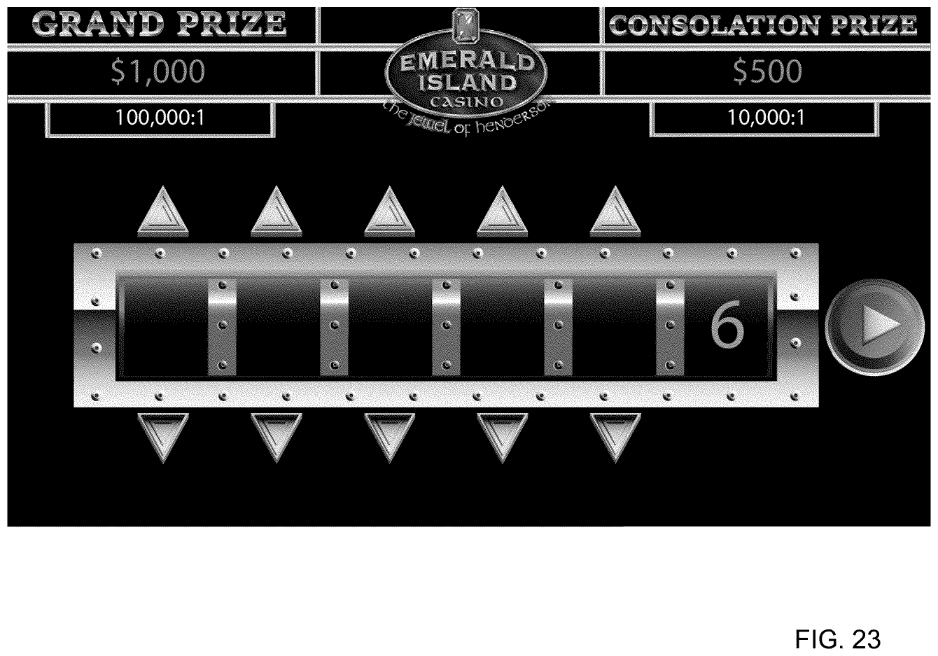

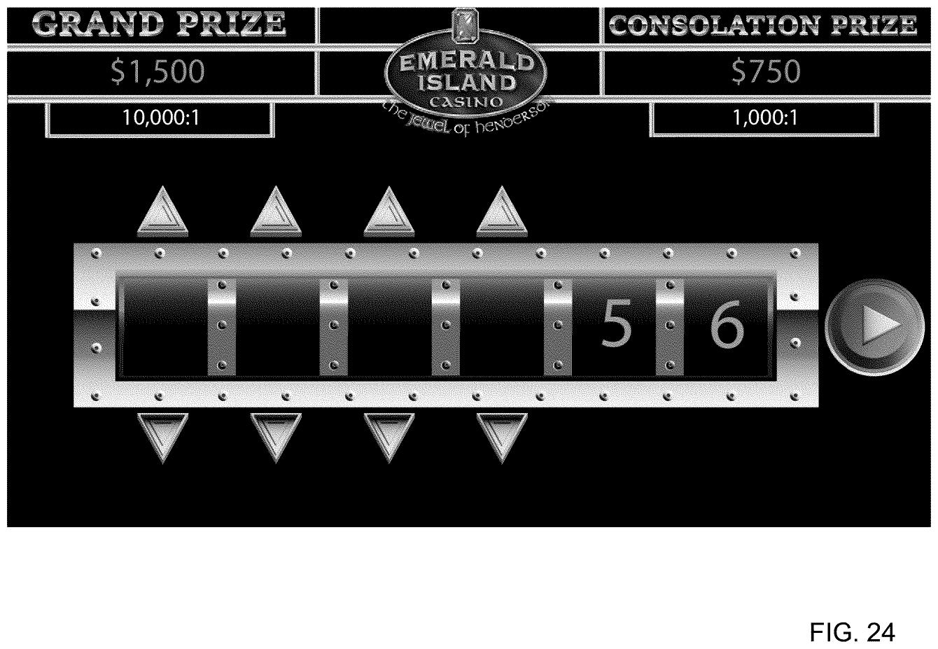

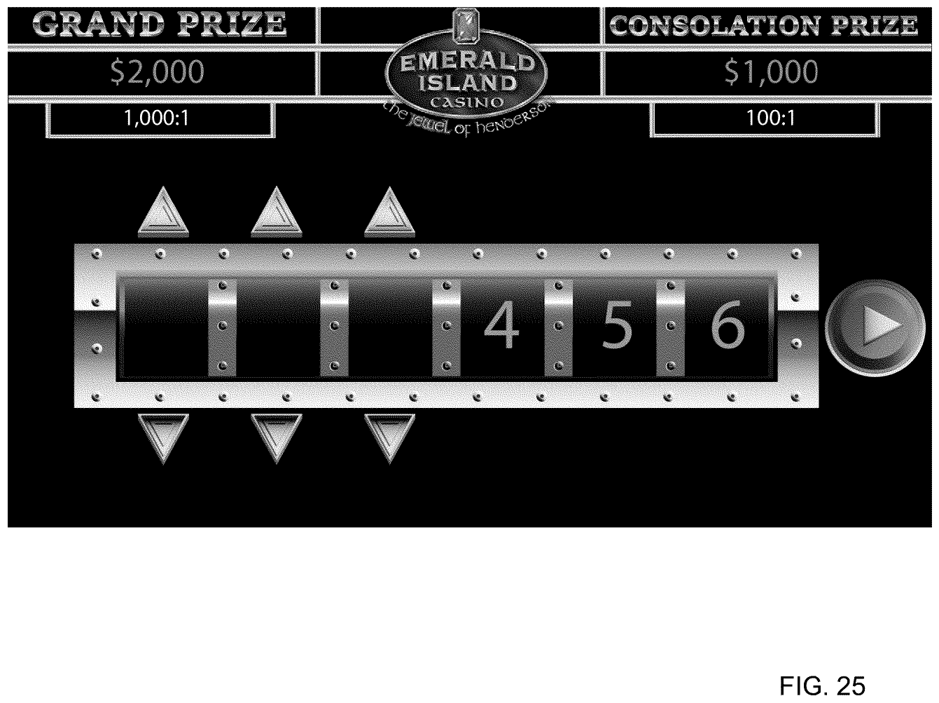

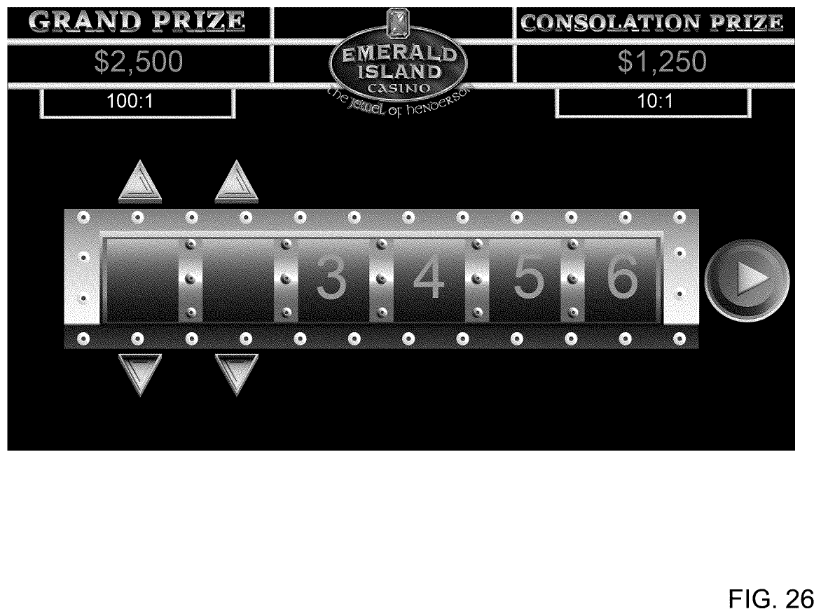

In a sixth step S10F (“(d)”), the virtual representation of the vault combination to be displayed on the display device 20C populated with the selected one(s) of the possible values (see FIGS. 23-26 and 30C, 30E, 30G, 30I, 30K and 30M). The player's guess of the vault combination is composed of the selected values.

In a seventh step S10G, steps (a)-(d) are repeated until all vault locations are populated. In an eighth steps S10H, the player's guess of the vault combination is compared against the vault combination and in a ninth step S10I, the player may be awarded a prize, for example, a grand prize or a consolation prize, as a function of the comparison between the guess of the one of the players with the predetermined combination.

With respect to the virtual representations of the vault combination and the population thereof with the player's selected values, the virtual representations are, in the illustrated embodiments, animations of the virtual combination locations being populated with the selected values.

The vault combination includes a predetermined number, m, of combination locations (for example 5 or 6 locations). In one embodiment, wherein player may be awarded a grand prize if the player correctly guesses the value in each combination location and a consolation prize of the player correctly guesses the value in m−1 of the combination locations.

In one embodiment of the present invention, the one of the players may be awarded a predetermined number of digital drawing tickets in response to the voucher being redeemed and the player being awarded neither the grand prize nor the consolation prize.

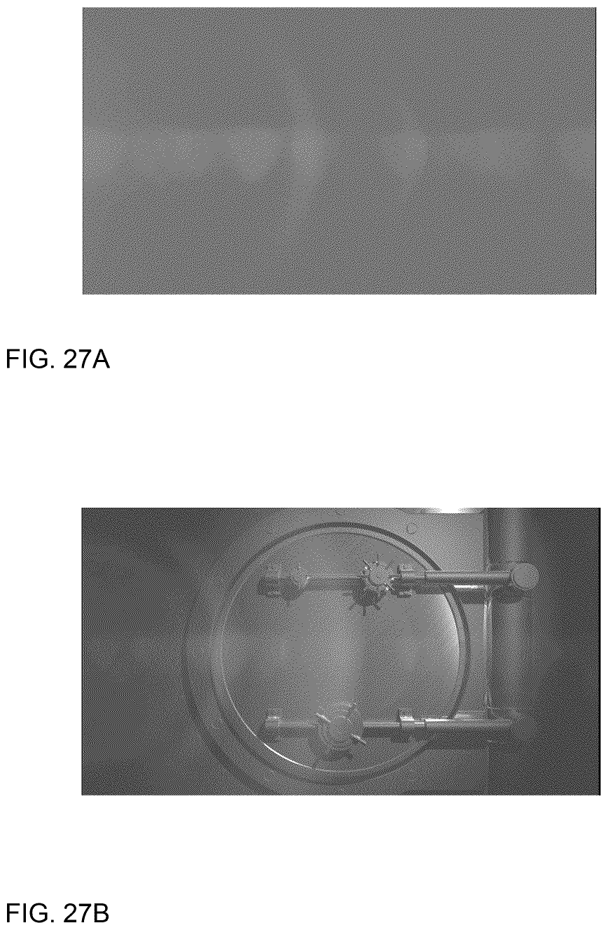

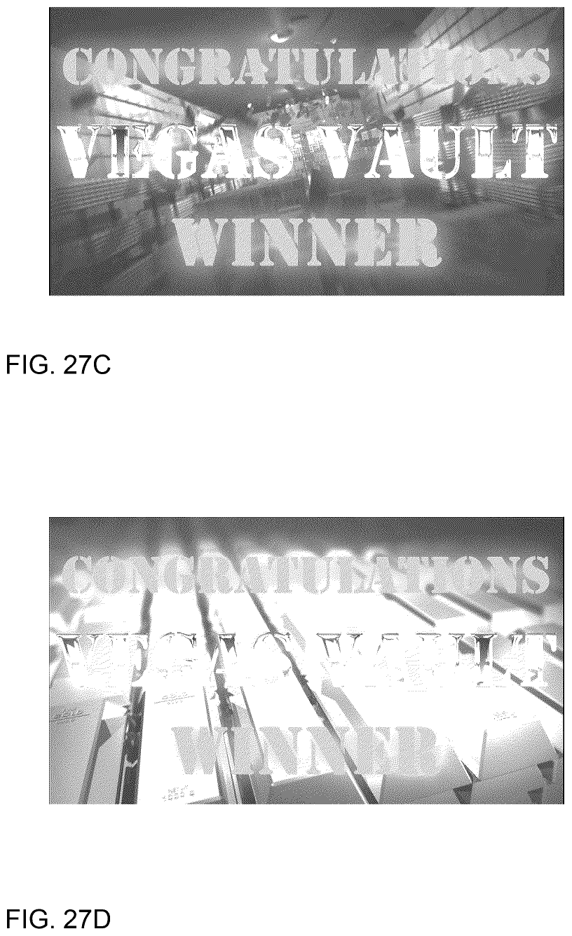

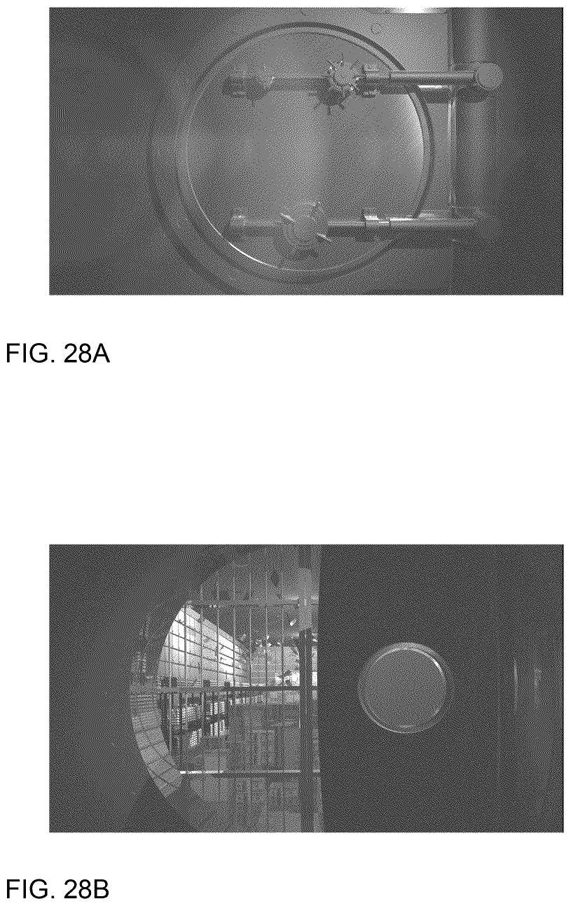

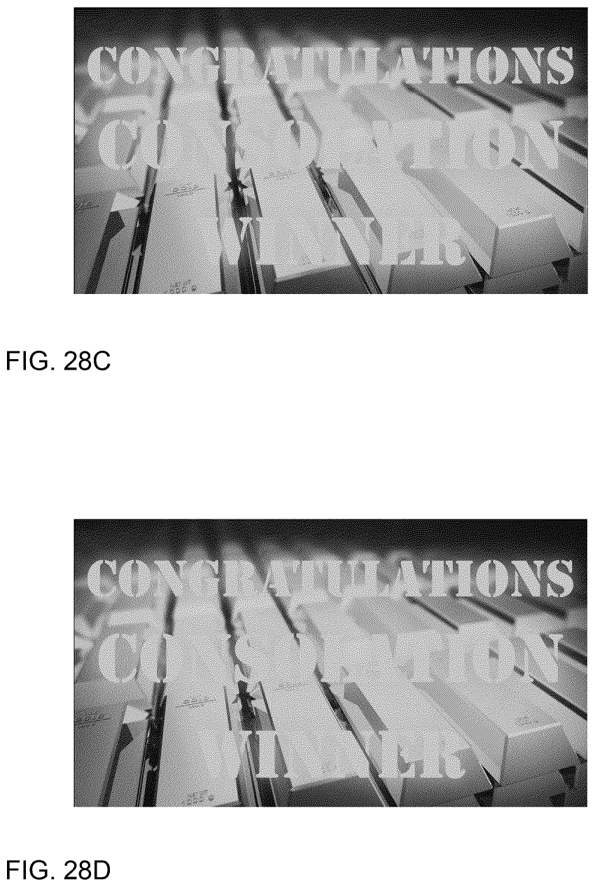

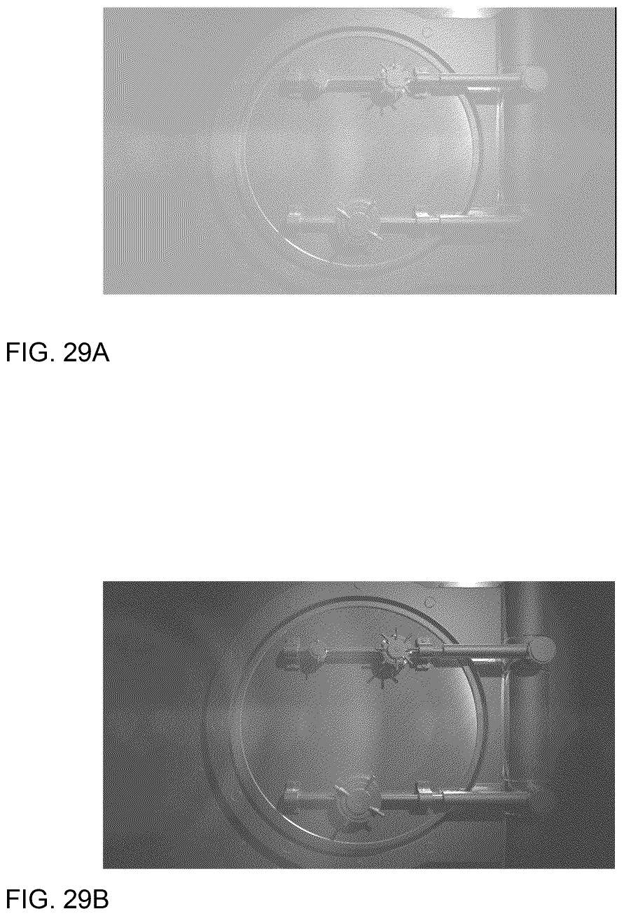

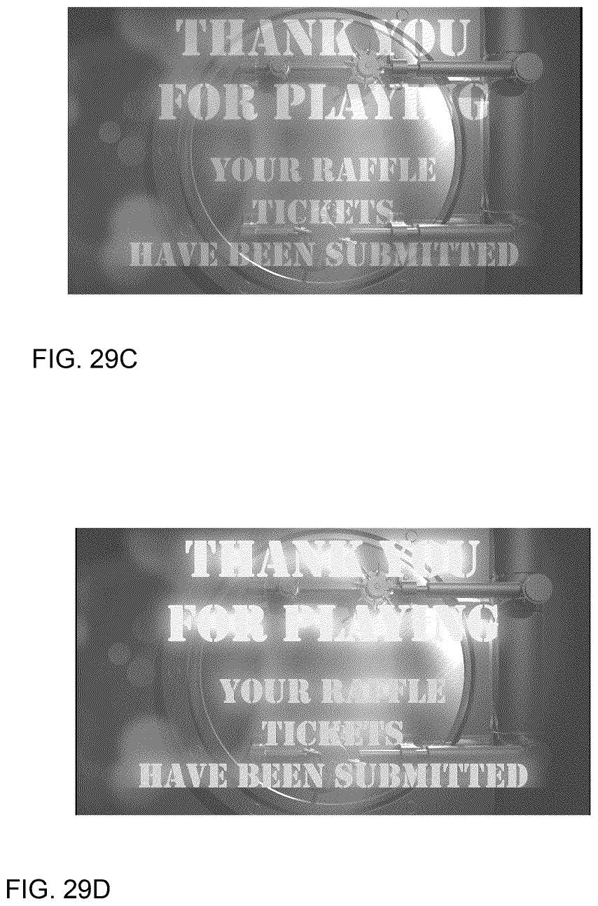

In another aspect of the present invention, the local computer device may cause different animations to be displayed on the display device 20C in response to the grand prize being awarded, the consolation prize being awarded, and/or digital drawing tickets being awarded (see FIGS. 27A-27D, 28A-28D, and 29A-29D, respectively).

In still another aspect of the present invention, the promotional game is configured to run for a set period, for example 5 or 6 weeks. Each successive week having passed without the grand prize and/or the consolation prize being awarded to one of the players, one of the vault combination location may be prepopulated (so the player has to correctly guess less than m locations), the grand and consolation prizes may be increased, and/or the predetermined number of drawing tickets are increased.

In another aspect of the present invention, the consolation prize may be reset to a consolation base amount after the consolation prize has been awarded to one of the players. In still one another embodiment, a player may be awarded a predetermined cash prize based on a number of vouchers redeemed by each player (during a given time period).

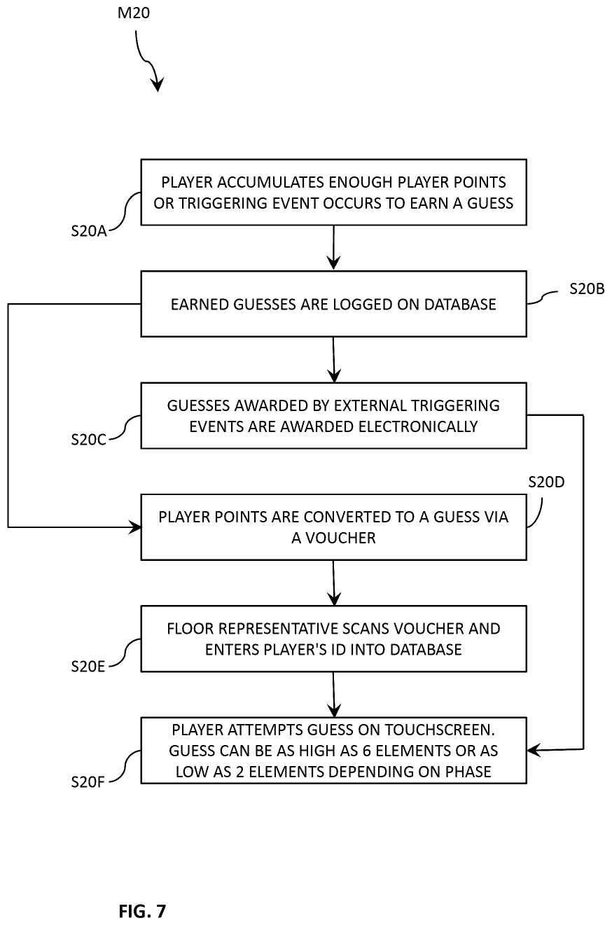

With specific reference to FIG. 7, a method M20 associated with the promotion game according to a second embodiment is shown. In a first step S20A, the player qualifies or earns an (opportunity) to play or guess at the secret combination. As discussed above, players may earn or qualify for a guess through a number of ways. For example, a player may accumulate enough player tracking points to qualify. Additionally, the player may earn one or more guesses based on an external triggering event (such as a winning condition at a gaming machine or station).

In a second step S20B, earned guesses are stored or logged into the database 6. In one embodiment, guesses earned by external triggers are awarded electronically and may be stored in the database as records or “vouchers” (third step S20C). Player points may also be converted into a guess via vouchers (electronic or paper) (fourth step S20D).

As discussed above, the player may redeem a voucher for a guess or guesses at, or using, the local computer 20. If for example, the player redeems a voucher at a kiosk or computer operated by a casino employee, in a fifth step S20E, the employee or floor representative may scan the voucher and enter the player's ID into the database 6. The player may then use the input device 20D, for example, the touchscreen to enter their guess. Based on the status or phase of the promotional game, the player may have to enter up to m (or 6) elements or as low as 2 elements.

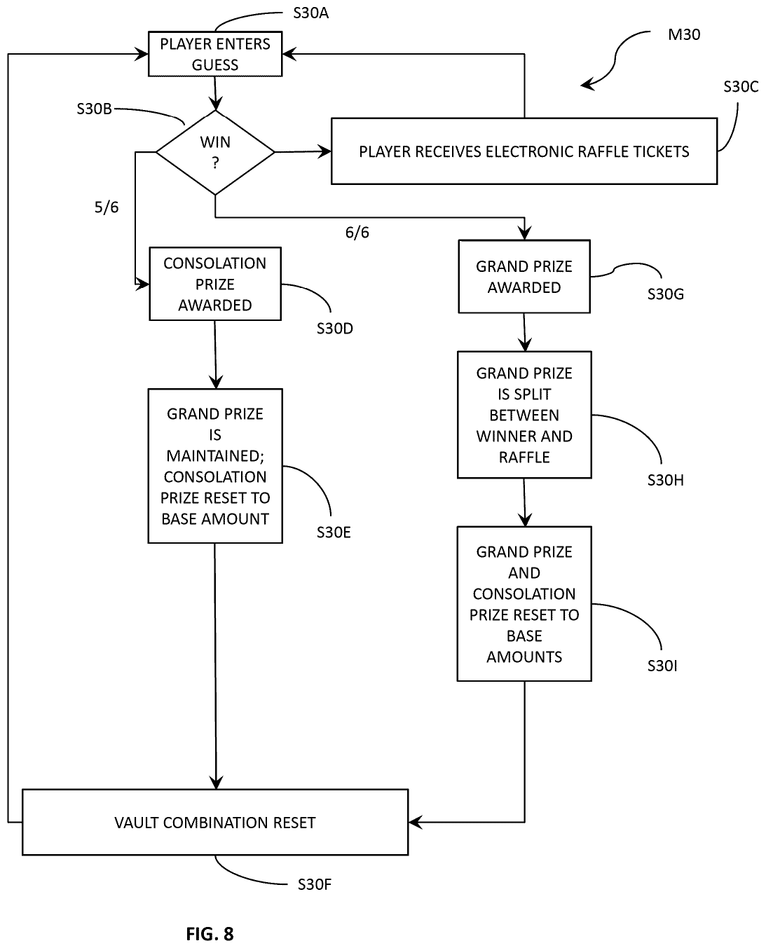

With particular reference to FIG. 8, a method M30 associated with the player entering a guess is shown.

In a first step S30A, the player enters their guess on the input device 20D. In a second step S30B, the player's guess is compared against the secret vault combination. If the guess does not match, the secret vault combination, then the method M30 proceeds to the second step S30C, and the player is awarded a number of electronic drawing tickets.

However, if the player's guess matches m−1 of the locations of the secret vault combination, then the method M30 proceeds to a fourth step S30D. In the fourth step S30D, the player is awarded the consolation prize. In a fifth step S30E, the grand prize is maintained at its current value and the consolation prize is reset to its based amount. In a sixth step S30F, the vault combination is reset (to a random value).

In the second step S30B, if the player's guess matches the values in all m locations, then the method M30 proceeds to a seventh step S30G. In the seventh step S30G, the player is awarded the grand prize S30G. In an eighth step S30H, the digital drawing is conducted, and a drawing prize is awarded. In one embodiment, the grand prize and the drawing prize is split from a grand prize pool.

In a ninth step S30I, the grand prize (or grand prize pool) and the consolation prize are reset to respective base amounts.

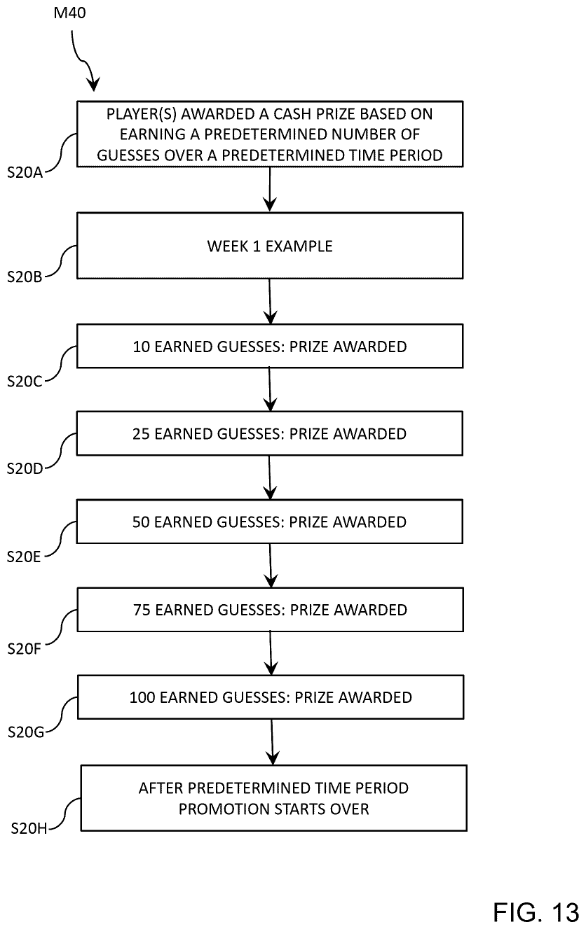

With reference to FIG. 13, in another aspect of the present invention, each player may be awarded a cash award based on the number of guesses awarded to that player during a predetermined time period, e.g., a week (S20A, S20B). A cash award may be awarded once the player reaches a predetermined number of guesses. In the illustrated embodiment, a player is awarded a cash prize once the player reaches the following number of guesses:
10 guesses (S20C),
25 guesses (S20D),
50 guesses (S20E),
75 guesses (S20F), and
100 guesses (S20G). Once the predetermined time period is over, the promotion starts over at 10 guesses.

In another embodiment, if the grand prize is won, only the grand prize is reset and the consolation prize continues to progress, in which case the new value of the grand prize may be lower than the value of the consolation prize. In some cases, it may be desirable to always maintain a larger grand prize than the consolation prize. Therefore, some embodiments of the present invention may be configured to switch to the amounts of the grand prize and consolation whenever the consolation prize exceeds the value of the grand prize. In a further embodiment, the present invention may be configured to make adjustments to the amounts of the grand prize and the consolation prize if the amount of the grand prize substantially exceeds the amount of the consolation prize. In yet another embodiment, the promoter is allowed to modify the amounts of the prizes.

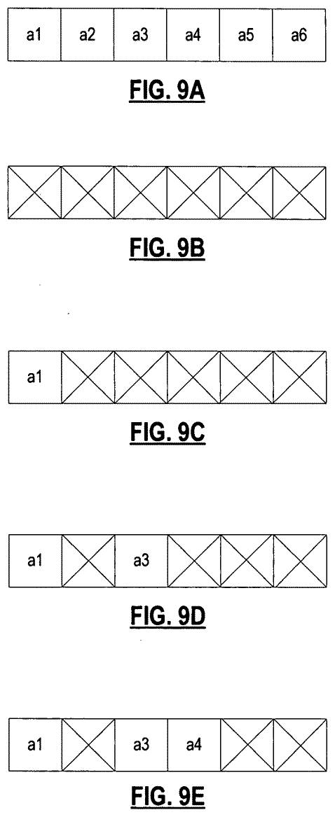

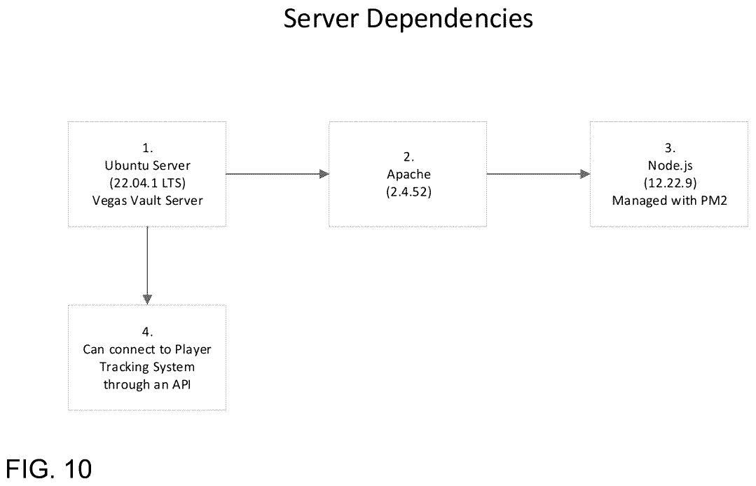

According to one embodiment of the present invention, it may be desired to reveal one component of the secret combination periodically in order to increase player interest in the game by making it easier for the players to correctly guess the secret combination. FIGS. 9A-9E show an exemplary embodiment of a secret combination having one element revealed periodically, according to an exemplary embodiment of the invention. FIG. 9A depicts an exemplary embodiment where the secret combination comprises a 6-element code consisting of elements (al) through (a6). As shown in FIG. 9B, when the secret combination is first generated, all the six elements of the secret combination are concealed. One element of the combination may be revealed after a predefined period, e.g. one month, dropping the odds of winning the grand prize. FIG. 9C depicts an example where element (al) has been revealed after the first month. Similarly, a second element can be revealed after the second month, increasing the odds of winning the grand prize even further. FIG. 9D depicts an example where element (a3) has been revealed after the second month. Further, a third element can be revealed after the third month, increasing the winning odds still further. FIG. 9E depicts an example where element (a4) has been revealed after the third month. Under this arrangement, in each month the players have a better chance of winning the grand prize or the consolation prize than the previous month. However, once either of the bonus prizes is won, a new secret combination is generated, the new combination having all its elements concealed.

There are various methods of financing the bonus prize. In one embodiment, financing is provided by keeping a count of the number of guesses that have been taken at the vault's secret combination within a certain period at each location. This function can be handled by the local computer 20, the input device 20D, or other means of keeping account of the number of guesses taken at the secret combination. Alternatively, each gaming station 22 may include a counter that keeps track of the number of times a guess at the secret combination has been taken from that game station within a given period. Based on the count from each game station, the total number of guesses at the secret combination for that location is calculated at the end of the period. Then, at the end of each period, each location will contribute money to the vault based the number of guesses taken within that location. In an exemplary embodiment, the owner of a gaming location may agree to contribute a certain amount. For example, per guess to the bonus prize. If two hundred players qualify for the promotional game within a month, that location has to contribute accordingly to the vault at the end of that month.

The vault provides incentives for owners of gaming locations to participate in the promotion plan in various ways. Primarily, the vault provides such incentive by drawing large crowds to these locations in hopes of winning the large vault prizes. In the embodiment where a component of the combination is revealed periodically, players have relatively good odds of winning large prizes as the game progresses without a winning guess. Therefore, large crowds can be attracted to the gaming locations that allow them to participate in the promotional game.

In one embodiment, a further incentive is provided for the owners of gaming locations to participate in the promotion plan. When a player wins a vault prize, the gaming location where the prize was won is awarded an additional percentage of the prize won. In an exemplary embodiment, for each prize won at a gaming location, that gaming location is awarded thirty percent of the amount of the prize as an additional bonus. This provides a further incentive to the owners of gaming locations to participate in the promotion plan and implement the promotional game within their gaming locations.

### INDUSTRIAL APPLICABILITY

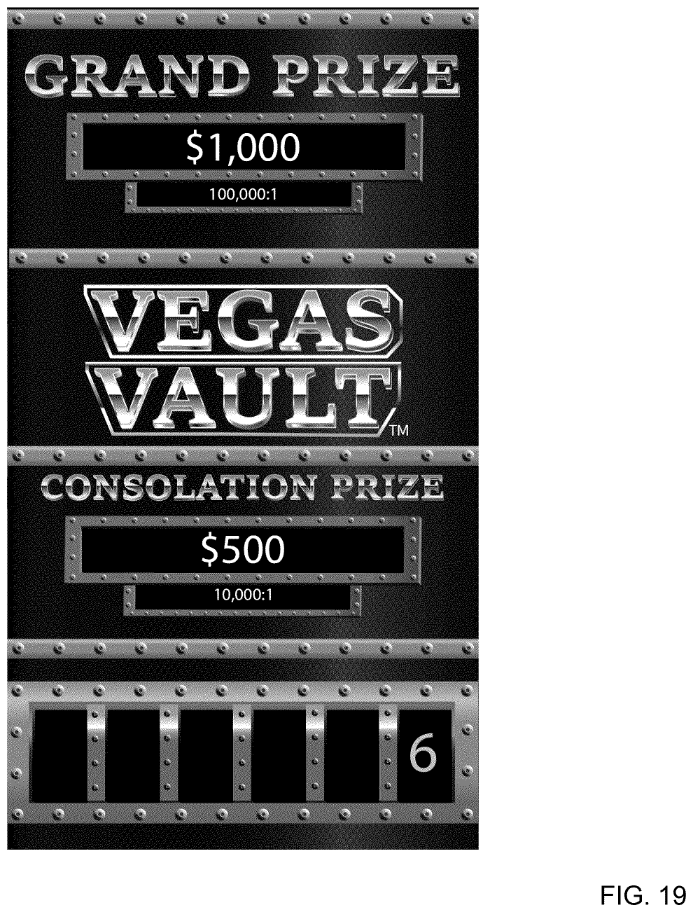

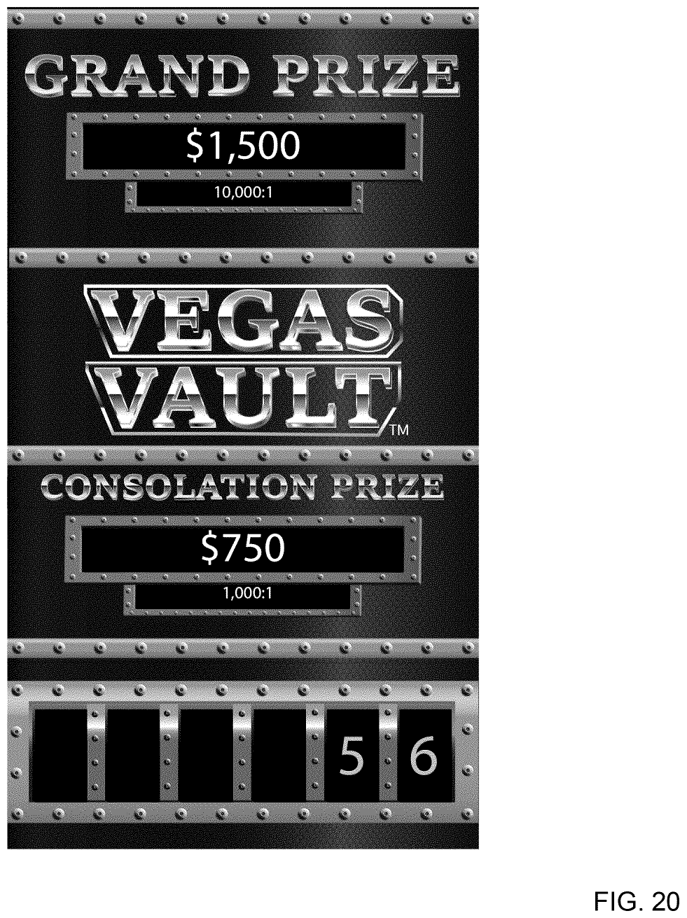

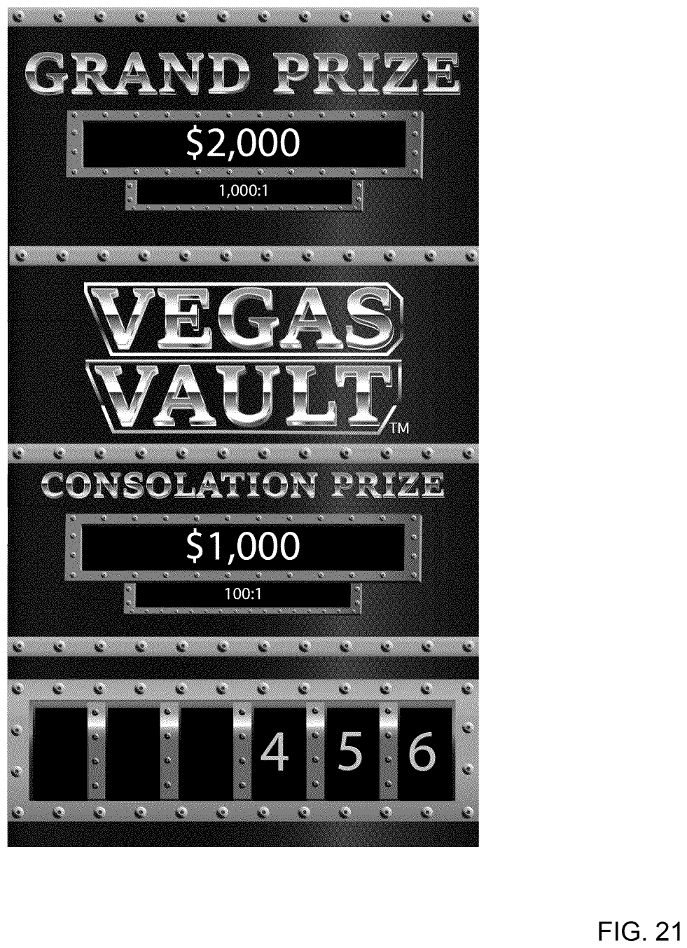

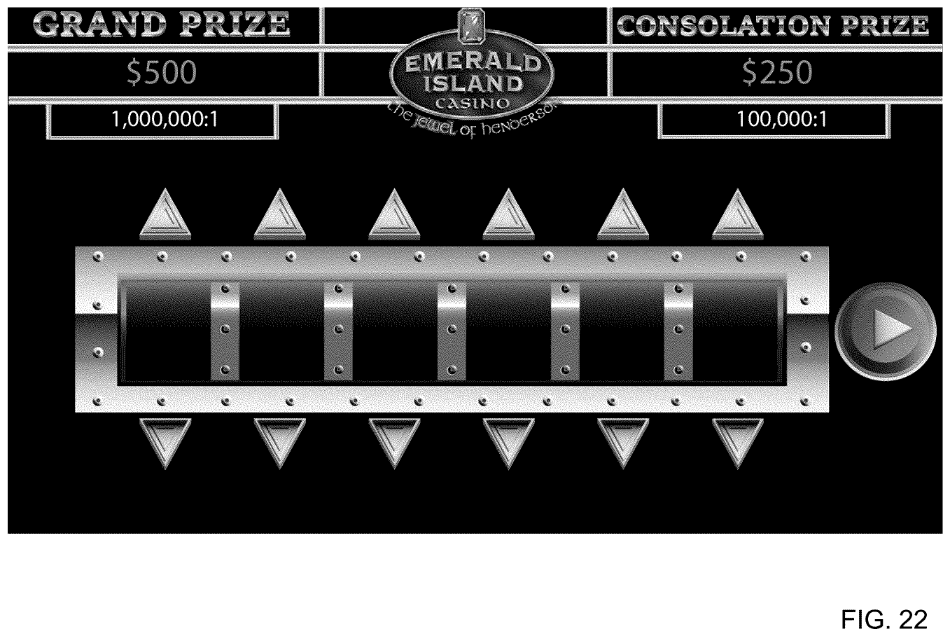

With reference to the drawings, and specifically, FIGS. 10-29 and 30A-3M, and in operation, the present invention may be embodied in a promotional game for the gaming industry referred to as the Vegas Vault or “VV” promotional game. The VV promotional game may use a vault concept that can be applied internally or externally to any game, chance or gaming network to enhance a players gaming experience and offer a form of monetary compensation for their play.

The Vegas Vault promotional game may be won by correctly guessing a secret combination of numbers, digits, letters or symbols or any combination of the three.

Players earn guesses at the Vegas Vault via a player tracking system with earned points or a triggered event, such as a winning condition in an underlying wagering game. The Vegas Vault promotional game bay be associated with any game of chance and be triggered by any event deemed appropriate or exist as an integral part of its own game.

VV offers advantages and odds that are often in the players favor, a scenario not seen in the gaming industry. VV is a dual payout promotion consisting of a vault combination guess winner and a player participation drawing winner.

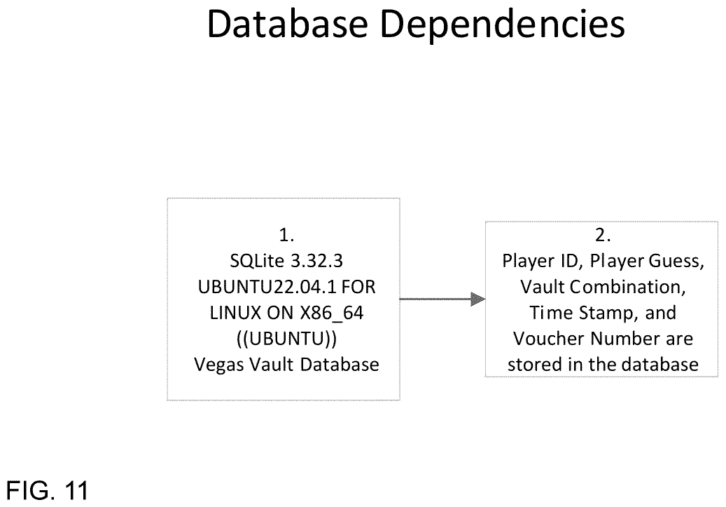

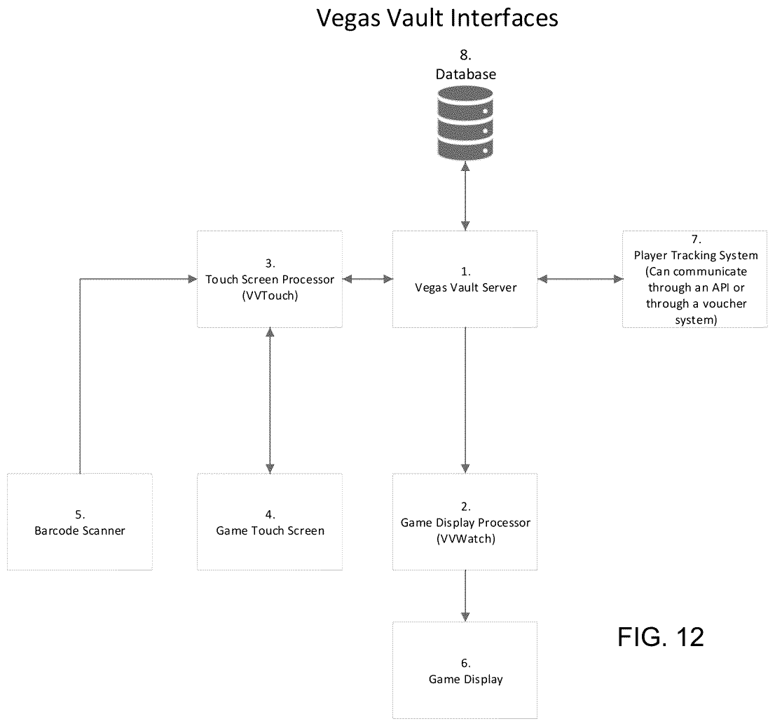

FIGS. 10 and 11 are graphic illustrations of the server dependencies and database dependencies according to the VV embodiment of the present invention. FIG. 12 is a graphic illustration of the VV interfaces.

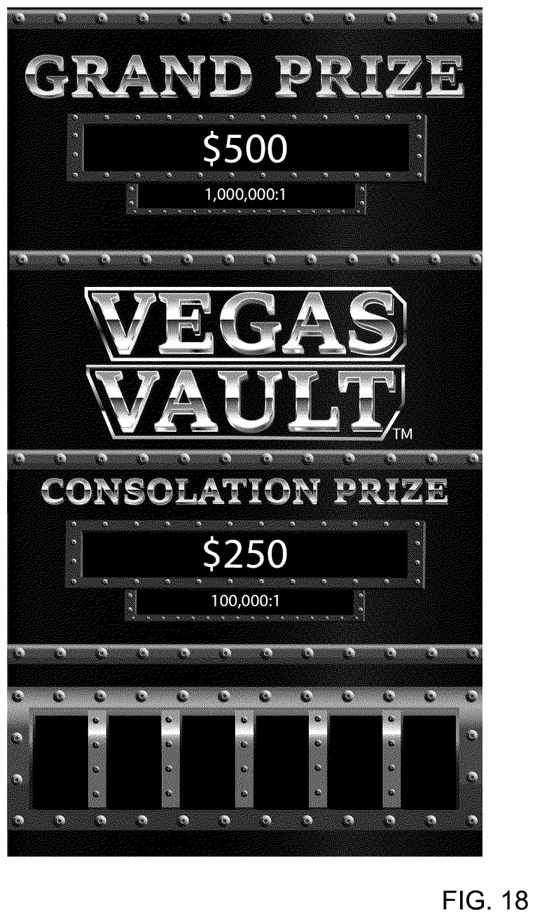

FIGS. 18-21 and FIGS. 22-26 are exemplary virtual representations of the vault combination as the vault combination is populated by a player's guess.

As previously stated VV can be attached to any game of skill, chance or gaming network. The promotion starts Week #1 with a hidden combination and two prizes both a consolation and grand prize. A player must trigger the game which can be done by any event of our choosing (i.e., 4 of a kind, player blackjack, points earned on a player redemption system etc.). Once the VV is triggered our player will receive a predetermined amount of drawing entries (number of drawing entries is dependent on what week the promotion is in) and an opportunity to take a guess at the VV combination.

The combination consists of any number of digits and/or letters VV chooses (the VV combination is based and set on the size of our target audience). Exemplary game flow is illustrated in FIGS. 13-15 (see above).

For the purpose of this demonstration, a simple six-digit combination is used. When a player triggers a guess on Week #1, the player will receive digital drawing entries and a guess at the six-digit combination to win either the consolation or the grand prize. The prize amounts can be set to any amount VV chooses (prize amounts to be set based on our target audience). For this demonstration we will start Week #1 with a $2,000 grand prize and a $1,000 consolation prize.

To win the grand prize a player must guess all six digits correctly. If a player guesses 5 out of the 6 digits correctly, they will win the consolation prize.

Please make note trigger events, number of drawing tickets, make up of vault combination, prize amounts, number of prizes and time frame of releasing digits can and will vary based on the discretion of VV as to what best suites our target audience.

| START OF WEEK | | |
|---|---|---|
| #1 | 100 DIGITAL DRAWING TICKETS | |
| GRAND PRIZE | 6 DIGITS (1 MILLION TO 1) | $2,000 |
| CONSOLATION | 5 DIGITS (100,000 TO 1) | $1,000 |

If there is no winner in Week #1 VV will increase the prize amounts to $4,000/$2,000 and VV will reveal one digit leaving only 5 digits needed to be guessed correctly to win the grand prize and 4 digits needed to be guessed correctly to win the consolation prize.

| START OF WEEK | | |
|---|---|---|
| #2 | 50 DIGITAL DRAWING TICKETS | |
| GRAND PRIZE | 5 DIGITS (100,000 TO 1) | $4,000 |
| CONSOLATION | 4 DIGITS (10,000 TO 1) | $2,000 |

If there is no winner in Week #2 VV will increase the prize amounts to $6,000/$3,000 and VV will reveal one more digit leaving only 4 digits needed to be guessed correctly to win the grand prize and 3 digits needed to be guessed correctly to win the consolation prize.

| START OF WEEK | | |
|---|---|---|
| #3 | 25 DIGITAL DRAWING TICKETS | |
| GRAND PRIZE | 4 DIGITS (10,000 TO 1) | $6,000 |
| CONSOLATION | 3 DIGITS (1,000 TO 1) | $3,000 |

If there is no winner in Week #3 VV will increase the prize amounts to $8,000/$4,000 and VV will reveal one more digit leaving only 3 digits needed to be guessed correctly to win the grand prize and 2 digits needed to be guessed correctly to win the consolation.

| START OF WEEK | | |
|---|---|---|
| #4 | 10 DIGITAL DRAWING TICKETS | |
| GRAND PRIZE | 3 DIGITS (1,000 TO 1) | $8,000 |
| CONSOLATION | 2 DIGITS (100 TO 1) | $4,000 |

After Week #4 VV will not reveal any additional digits the game will play out till either the grand prize or consolation prize is won. We expect a prize to be won during this week however if for some reason there is no winner VV will increase the prize amounts to $10,000/$5,000 BUT VV WILL NOT REVEAL ANYMORE DIGITS.

| START OF WEEK | | |
|---|---|---|
| #5 | 5 DIGITAL DRAWING TICKETS | |
| GRAND PRIZE | 3 DIGITS (1,000 TO 1) | $10,000 |
| CONSOLATION | 2 DIGITS (100 TO 1) | $5,000 |

Any time the consolation prize is won (by the player guessing 5 out of 6 digits correctly) the consolation prize will reset to its initial Week #1 amount (for this demonstration is $1,000) the VV will reset a new six-digit hidden combination the grand prize will remain the same and continue to increase weekly till the grand prize is won.

When the grand prize is won (by the player guessing all 6 digits correctly) the player guessing the combination correctly will be awarded 50% of the grand prize amount. VV will draw a player participation drawing winner who will receive the remaining 50% of the grand prize. The consolation prize funds will be returned to VV and both prizes will reset to their original Week #1 amounts (for this demonstration is $2,000/$1,000) and VV will reset a new six-digit hidden combination and the promotion will re-start back at Week #1.

In summary, VV is a promotional game for the gaming industry, using a vault concept that can be applied internally or externally to any game of skill, chance, or gaming network to enhance a players gaming experience and offer a form of monetary compensation for their play and cultivate new players. The consolation prize will theoretically be won ten times more frequently than the grand prize based on the simple mathematical odds. This will allow the grand prize to increase frequently to larger amounts while it becomes easier to win due to the weekly revealing of a digit from the vault combination. We expect these scenarios will increase a players play time and denomination amount (especially when tied to a player reward system). We expect a significant increase in a locations coin-in. We expect these spikes on a regular basis as the game cycles and plays and the odds transition into the player's favor. We expect to introduce new gamers to our Vegas Vault locations from other locations and as the grand prize increases even more create entirely new players that will in turn patronage our Vegas Vault locations.

Customers participate in Vegas Vault by playing any of the games on the casino floor. When they do so they earn points and when they meet a certain criteria they are alerted by the casino they have been awarded a guess at the Vegas Vault and where they can go to redeem that guess. A player will alert the redemption employee that he/she was instructed to come redeem their guess at the Vegas Vault. The player will be asked to provide his/her player identification number or card. Once the number or card is validated for a guess the player will first receive a printed digital drawing slip denoting exactly how many digital entries they have been awarded. (number of drawing tickets awarded changes based on what week the promotion is in see above) Those entries are immediately entered and valid for the next drawing (which occurs when the grand prize is won by guessing the full 6 digit combination correctly see above). After receiving their drawing entries, they will be given access to the Vegas Vault system and allowed to enter their guess at the combination.

In another aspect of the invention, the Vegas Vaults promotional game may include a count feature. The count feature may be a count on vault guesses earned per player per week so basically a race to predetermined amounts paying the winning players pre-determined amounts of cash and again that is on a weekly basis. The other elements of the vault have no bearing on this portion of the promotion this operates the same every week on its own.

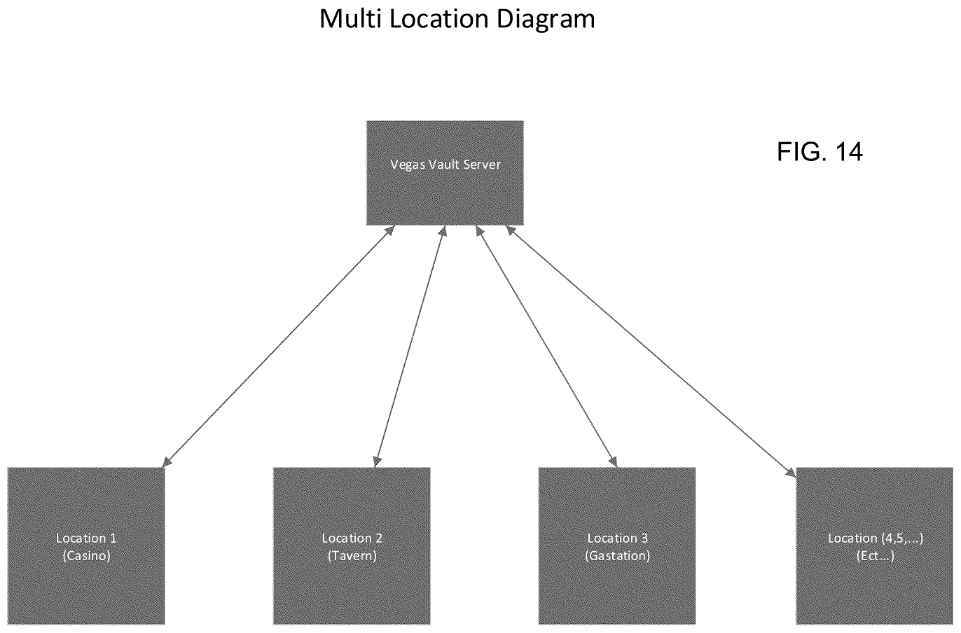

The Vegas Vault promotional game may be provided across multiple properties or casinos (see FIG. 14). Various exemplary graphics are shown in FIGS. 15-29 and 30A-30M.

As previously stated, Vegas Vault can be operated with any number of digits and/or letters acting as the hidden combination. In an alternative embodiment, as shown in FIGS. 30A-30M, the vault combination consists of a 6 digits. However, the possible values are a two digit number from 00-99, creating a six-digit combination with each digit being a double-digit number (see FIGS. 30A-30M)

As previously stated, the Vegas Vault prize structure is broken down into three prizes, a consolation prize, a grand prize combination winner and a grand prize drawing winner. All those prizes and pay off structures will remain the same. In an alternative embodiment, after a certain number of consecutive consolation wins (in this case 7) Vegas Vault will enter GRAND PRIZE ONLY mode and the game will reset without a consolation prize. The game will continue to play as normal releasing digits until the grand prize is won. Once the grand prize is won the game will reset to its original week one settings and prize structures offering all three prizes.

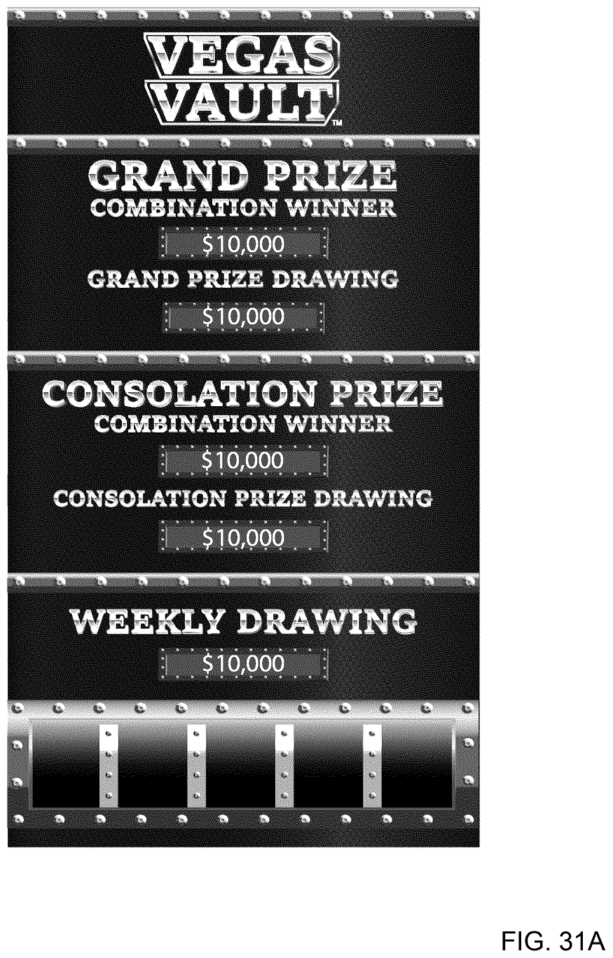

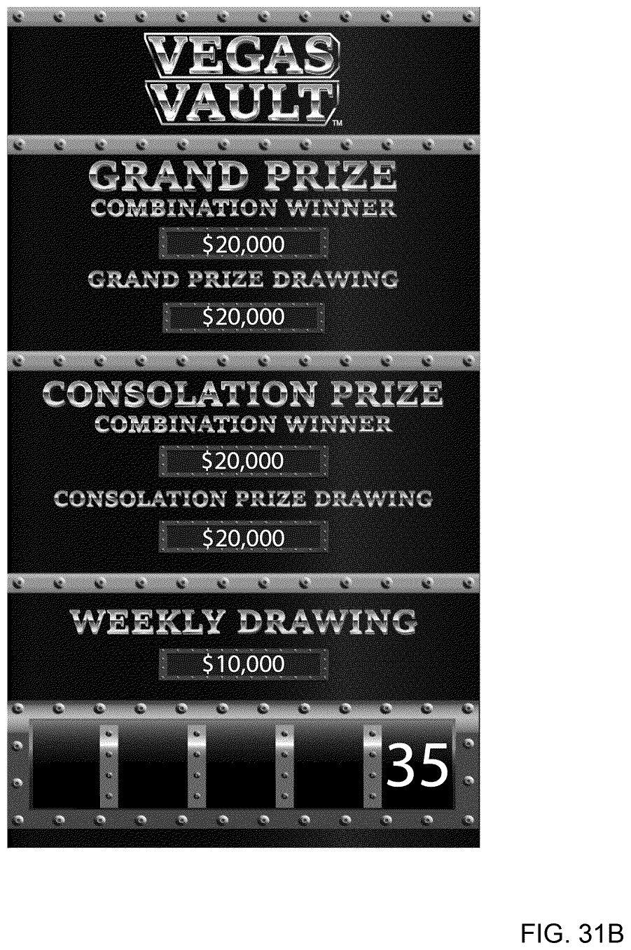

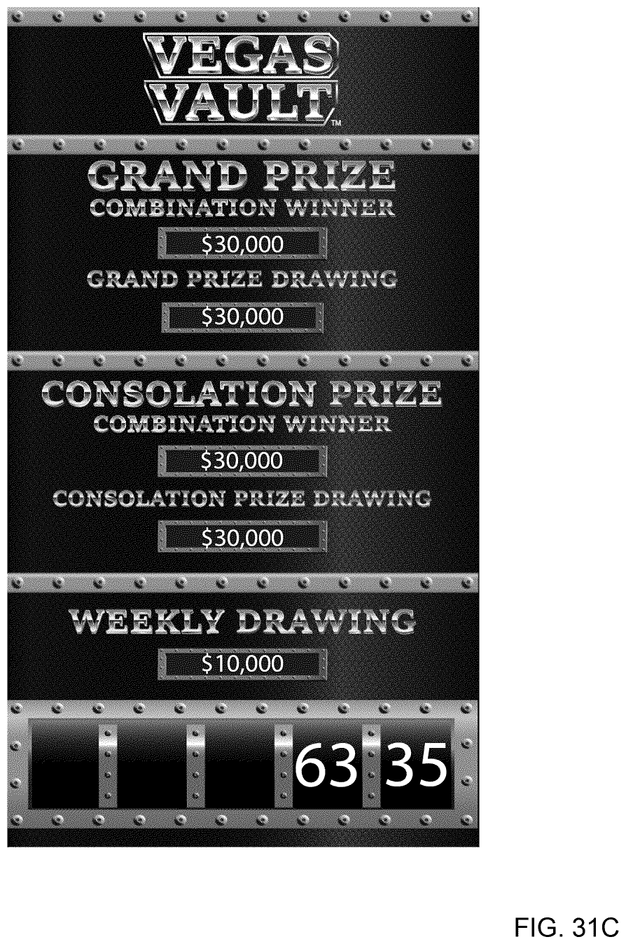

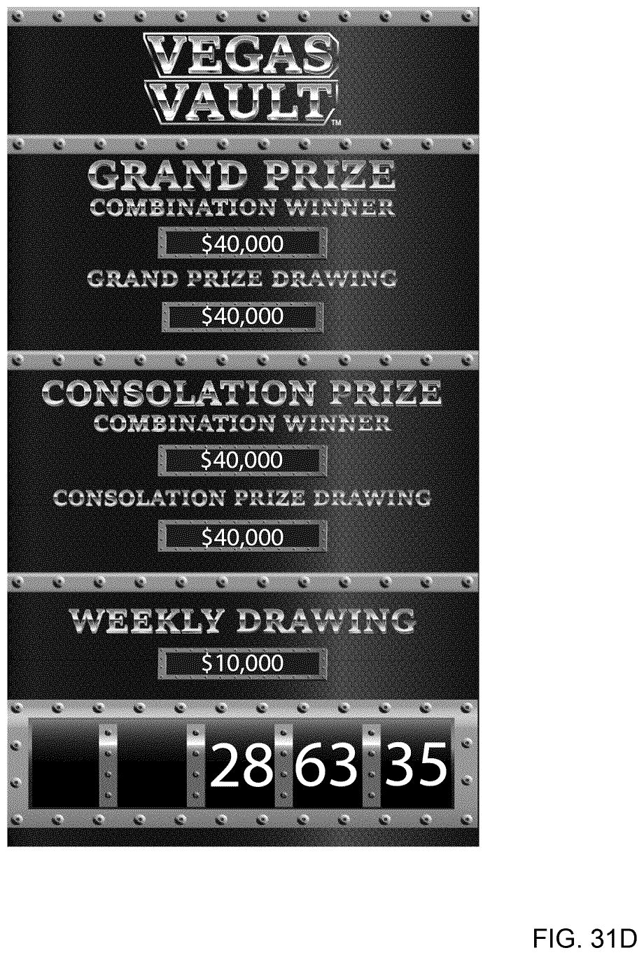

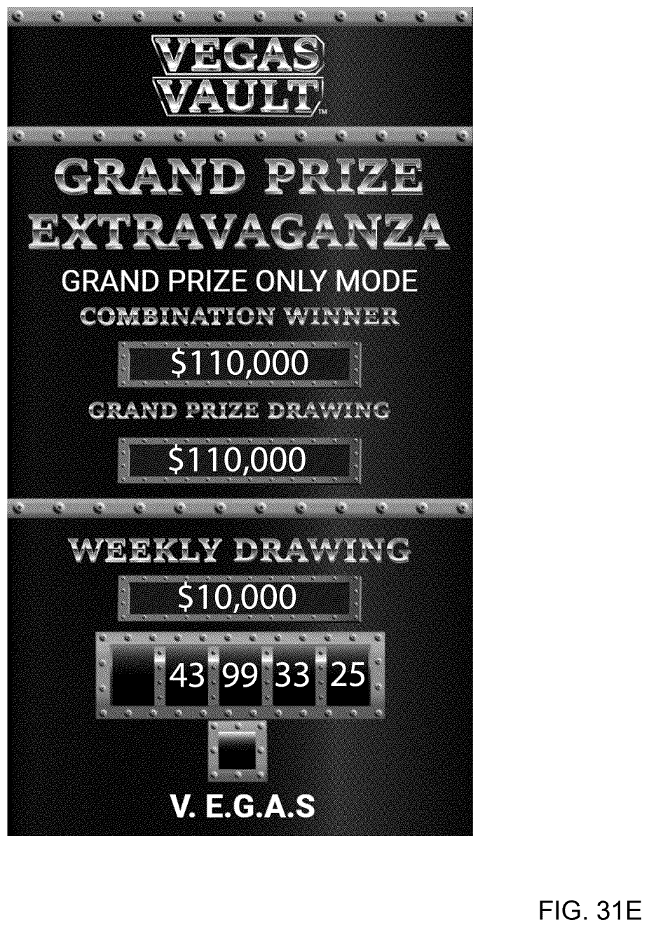

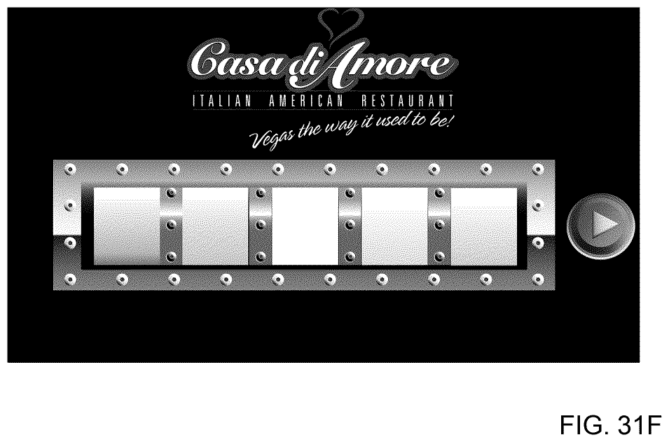

With reference to FIGS. 31A-31E, a number of graphics utilized in an alternative version of the Vegas Vault promotional game are shown. The illustrated version of the VV promotional game includes a modified prize structure. As described above, grand and consolation prizes are awarded based on a player's guess at the secret vault combination. As discussed above, every predetermined time period, for example, one week, without a grand prize or consolation prize being awarded, one or another one of the values in the secret combination are revealed and displayed. In additional, the VV network system 2 will automatically conduct or perform the random drawing from the virtual weekly drawing bin (i.e., awarded drawing tickets).

In additional, a random drawing will be performed every time a grand prize or a consolation prize is awarded. In the illustrated embodiment, the secret combination includes 5 locations, each including a random number, symbol and/or letter. Thus, a consolation prize is awarded to a player, if the player correctly guesses 4 out 5 of the secret combination (including any revealed value). In this embodiment, when the consolation prize is won by one of the players, the Vegas Vault system 2 will automatically draw a consolation prize drawing winner from the virtual consolation prize drawing bin. When the consolation prize(s) are won the consolation prizes will reset to their original Week 1 starting amounts. The grand prizes will continue to increase weekly, a new secret combination will be selected by the RNG, and the game will reset to zero digits or values revealed and the game will continue on.

In the illustrated embodiment, when a player guesses 5 out of 5 numbers correctly, the grand prize is awarded to the player. In addition, the Vegas Vault system 2 will automatically draw a grand prize drawing winner from the virtual grand prize drawing bin. When the grand prize(s) are won both the grand prizes and the consolation prizes will reset to their original Week 1 starting amounts, a new secret combination will be selected by the RNG the game will reset to zero digits revealed, and the game will start all over.

The version of the Vegas Vault Promotional Game shown in FIGS. 31A-31B uses a 5 number combination with each number ranging from 00-99 making the odds of guessing each number correctly 100 to 1. However, it should be noted again the combination can consist of any amount of numbers, digits, letters or symbols or any combination of the three deemed appropriate.

One or more of the numbers in the secret combination are revealed each week during which a grand or consolation prize is not won, but can be also released or revealed on any predetermined or random time frame essentially creating community numbers that will be used by all players making it significantly easier to guess the correct combination as the weeks go by and numbers are revealed and the jackpots increase.

When either the CONSOLATION PRIZE or the GRAND PRIZES are won a new combination is selected by the RNG and the game is restarted with zero digits revealed.

Players not only earn guesses at the Vegas Vault combination they also earn drawing entries with each guess. The number of drawing entries awarded to each player is directly correlated to the number of digits revealed when the drawing entries are earned. Players get more entries when less digits are revealed and less entries when more digits are revealed. This gives the players incentive to play during the early weeks of the game when the odds to guess the combination correctly are higher and more difficult.

The VV system 2 may include three separate virtual drawing bins all operating separately and independent of each other populating according to the players weekly participation.

In the illustrated embodiment (FIGS. 31A-31F), the secret combination includes 5 locations. The value in each location is a two digit number from 00-99. However, in the Grand Prize only mode, the secret combination is composed of letters, e.g., “VEGAS”.

FIGS. 31A-31E represent exemplary graphics that may be displayed on various display screens throughout the system 2 including the local computers 20, e.g., kiosk, employee workstation, player tracking devices and/or stand-alone large monitors located throughout a gaming location. As shown, the graphics display the current status of the promotional game including the current values of the grand prize, grand prize drawing, consolation prize, consolation prize drawing and weekly drawing. A virtual representation of the secret vault combination may also be included with any revealed vault locations shown. The virtual representations may be color coded based on the status of the game, for example:
RED SCREEN—ZERO NUMBERS REVEALED (FIG. 31A),
PINK SCREEN—ONE NUMBER REVEALED (FIG. 31B),
BLUE SCREEN—TWO NUMBERS REVEALED (FIG. 31C),
GREEN SCREEN—THREE NUMBERS REVEALED (FIG. 31D), and
PURPLE SCREEN—UP TO FOUR DIGITS REVEALED (GRAND PRIZE ONLY MODE).

After a predetermined number of consecutive consolation prize wins Vegas Vault may enter into the Grand Prize Only mode. The consolation prizes will go away and we reveal up to 4 out of the 5 numbers and play until we have a grand prize winner. Players will have to guess all the 5 numbers correctly and, additionally, the correct letter out of a provide word, e.g., V. E. G. A. S.

FIG. 31F, an exemplary graphic embodying the input screen through which players enter their guess at the secret combination.

The foregoing invention has been described in accordance with the relevant legal standards, thus the description is exemplary rather than limiting in nature. Variations and modifications to the disclosed embodiment may become apparent to those skilled in the art and fall within the scope of the invention.

What is claimed is:

1. A networked computer system for providing a promotional game to a plurality of users, the promotional game includes one or more prizes to be awarded to the plurality of users in response to successful guessing of a predetermined vault combination, the vault combination includes a predetermined number of combination locations, comprising:
a central server system configured to be connected to a plurality of gaming machines by a network, the central server system coupled to a player tracking system, the player tracking system configured to monitor game play and/or other activity of each of the plurality of players and to assign player points to each player as a function thereof; and,
a database configured to store a player account associated with each of the plurality of players, each player account including a number of player points associated with an associated player; and,
a local computing device connected to the central server system including a display device and an input device, the central server system configured to perform the steps of:
providing one of the players a voucher in response to (1) the one of the players accruing a predetermined number of player points in the associated player account, or (2) occurrence of an external triggering event,
allowing the one of the players to redeem the voucher at the local computer device, wherein the local computer device, in response to redemption of the voucher, is configured to:
(a) cause display, by the display device, of a virtual representation of the vault combination, wherein each of the predetermined number of combination locations is empty,
(b) cause display, by the display device, of a virtual representation of a plurality possible values associated with the predetermined number of combination locations,
(c) allow the one of the players to select one of the plurality of possible values from the virtual representation of a plurality of possible values,
(d) cause display, by the display device, of the virtual representation of the vault combination, with the selected one of the plurality of possible values being shown in one of the combination locations, and,
(e) repeating steps (b)-(d) until all combination locations have a selected one of the plurality of possible values, the selected ones of the plurality of possible values comprising a guess of the one of the players,
the central server system being further configured to perform the steps of:
comparing the guess of the one of the players with the predetermined combination,
awarding the one of the players a prize as a function of the comparison between the guess of the one of the players with the predetermined combination.

2. The networked computer system, as set forth in claim 1, wherein the number of combination locations in the vault combination is m, wherein the prize awarded to the one of the players is (1) a grand prize if the guess of the one of the players matches all values in the vault combination and (2) a consolation prize if the guess of the one of the players matches m−1 values in the vault combination.

3. The networked computer system, as set forth in claim 2, wherein the one of the players is awarded a predetermined number of drawing tickets in response to the voucher being redeemed and the player being awarded neither the grand prize nor the consolation prize.

4. The networked computer system, as set forth in claim 3, wherein the local computer device, is configured to:
cause, by the display device, a first animation to be displayed in response to the grand prize being awarded;
cause, by the display device, a second animation to be displayed in response to the consolation prize being awarded; and,
cause, by the display device, a third animation to be displayed in response to the drawing tickets being awarded.

5. The networked computer system, as set forth in claim 4, wherein after each successive week having passed without the grand prize or consolation prize being awarded to one of the players:
one of the vault combination locations is prepopulated,
the grand and consolation prizes are increased, and
the predetermined number of drawing tickets are increased.

6. The networked computer system, as set forth in claim 1, wherein the consolation prize is reset to a consolation base amount after the consolation prize has been awarded to one of the players.

7. The networked computer system, as set forth in claim 6, wherein the possible values are two digits ranging from 00 to 99.

8. The networked computer system, as set forth in claim 1, wherein each player is awarded a predetermined cash prize based on a number of vouchers redeemed by each player.

9. The networked computer system, as set forth in claim 8, wherein the predetermined cash prize is a function of the number of vouchers redeemed by each player in a week.

10. The networked computer system, as set forth in claim 1, wherein the voucher provided to one of the players is a physical voucher if based on player tracking points.

11. The networked computer system, as set forth in claim 10, wherein the voucher provided to one of the players is an electronic voucher if based on an external triggering event.

12. A computer-based method, implemented by a networked computer system, for providing a promotional game to a plurality of users, the promotional game includes one or more prizes to be awarded to the plurality of users in response to successful guessing of a predetermined vault combination, the vault combination includes a predetermined number of combination locations, the networked computer system including a central server system, a database, and a local computer device, the central server system configured to be connected to a plurality of gaming machines by a network, the central server system coupled to a player tracking system, the player tracking system configured to monitor game play and/or other activity of each of the plurality of players and to assign player points to each player as a function thereof, the database coupled configured to store a player account associated with each of the plurality of players, each player account including a number of player points associated with an associated player, the local computing device connected to the central server system including a display device and an input device, the computer based method including the steps of:
providing one of the players a voucher in response to (1) the one of the players accruing a predetermined number of player points in the associate player account, or (2) occurrence of an external triggering event;
allowing the one of the players to redeem the voucher at the local computer device;
in response to redemption of the voucher, performing, by the local computer device voucher, is configured to perform the steps of:
(a) causing display, by the display device, of a virtual representation of the vault combination, wherein each of the predetermined number of combination locations is empty,
(b) causing display, by the display device, of a virtual representation of a plurality possible values associated with the predetermined number of combination locations,
(c) allowing the one of the players to select one of the plurality of possible values from the virtual representation of a plurality of possible values,
(d) causing display, by the display device, of the virtual representation of the vault combination, with the selected one of the plurality of possible values being shown in one of the combination locations, and,
(e) repeating steps (b)-(d) until all combination locations have a selected one of the plurality of possible values, the selected ones of the plurality of possible values comprising a guess of the one of the players,
the central server system being further configured to perform the steps of:
comparing the guess of the one of the players with the predetermined combination,
awarding the one of the players a prize as a function of the comparison between the guess of the one of the players with the predetermined combination.

13. The computer-based method, as set forth in claim 12, wherein the number of combination locations in the vault combination is m, wherein the prize awarded to the one of the players is (1) a grand prize if the guess of the one of the players matches all values in the vault combination and (2) a consolation prize if the guess of the one of the players matches m−1 values in the vault combination.

14. The computer-based method, as set forth in claim 13, wherein the one of the players is awarded a predetermined number of drawing tickets in response to the voucher being redeemed and the player being awarded neither the grand prize nor the consolation prize.

15. The computer-based method, as set forth in claim 14, wherein the local computer device, is configured to:
cause, by the display device, a first animation to be displayed in response to the grand prize being awarded;
cause, by the display device, a second animation to be displayed in response to the consolation prize being awarded; and,
cause, by the display device, a third animation to be displayed in response to the drawing tickets being awarded.

16. The computer-based method, as set forth in claim 15, wherein after each successive week having passed without the grand prize or consolation prize being awarded to one of the players:
one of the vault combination location is prepopulated,
the grand and consolation prizes are increased, and
the predetermined number of drawing tickets are increased.

17. The computer based method, as set forth in claim 12, wherein the consolation prize is reset to a consolation base amount after the consolation prize has been awarded to one of the players.

18. The computer-based method, as set forth in claim 17, wherein the possible values are two digits ranging from 00 to 99.

19. The computer-based method, as set forth in claim 12, wherein each player is awarded a predetermined cash prize based on a number of vouchers redeemed by each player.

20. The computer-based method, as set forth in claim 19, wherein the predetermined cash prize is a function of the number of vouchers redeemed by each player in a week.

21. The computer-based method, as set forth in claim 12, wherein the voucher provided to one of the players is a physical voucher if based on player tracking points.

22. The computer-based method, as set forth in claim 21, wherein the voucher provided to one of the players is an electronic voucher if based on an external triggering event.

23. A computer-based method, implemented by a networked computer system, for providing a promotional game to a plurality of users, the promotional game includes one or more prizes to be awarded to the plurality of users in response to successful guessing of a predetermined vault combination, the vault combination includes a predetermined number of combination locations, the networked computer system including a central server system, a database, and a local computer device, the central server system configured to be connected to a plurality of gaming machines by a network, the central server system coupled to a player tracking system, the player tracking system configured to monitor game play and/or other activity of each of the plurality of players and to assign player points to each player as a function thereof, the database coupled configured to store a player account associated with each of the plurality of players, each player account including a number of player points associated with an associated player, the local computing device connected to the central server system including a display device and an input device, the computer based method including the steps of:
providing one of the players a voucher in response to (1) the one of the players accruing a predetermined number of player points in the associate player account, or (2) occurrence of an external triggering event;
allowing the one of the players to redeem the voucher at the local computer device;
in response to redemption of the voucher, performing, by the local computer device voucher, is configured to perform the steps of:
(a) causing display, by the display device, of a virtual representation of the vault combination, wherein each of the predetermined number of combination locations is empty,
(b) causing display, by the display device, of a virtual representation of a plurality possible values associated with the predetermined number of combination locations,
(c) allowing the one of the players to select one of the plurality of possible values from the virtual representation of a plurality of possible values,
(d) causing display, by the display device, of the virtual representation of the vault combination, with the selected one of the plurality of possible values being shown in one of the combination locations, and,
(e) repeating steps (b)-(d) until all combination locations have a selected one of the plurality of possible values, the selected ones of the plurality of possible values comprising a guess of the one of the players,
the central server system being further configured to perform the steps of:
comparing the guess of the one of the players with the predetermined combination,
awarding the one of the players a prize as a function of the comparison between the guess of the one of the players with the predetermined combination,
wherein the number of combination locations in the vault combination is m, wherein the prize awarded to the one of the players is (1) a grand prize if the guess of the one of the players matches all values in the vault combination and (2) a consolation prize if the guess of the one of the players matches m−1 values in the vault combination,
wherein the one of the players is awarded a predetermined number of drawing tickets in response to the voucher being redeemed and the player being awarded neither the grand prize nor the consolation prize,
wherein after each successive week having passed without the grand prize or consolation prize being awarded to one of the players:
one of the vault combination location is prepopulated,
the grand and consolation prizes are increased, and
the predetermined number of drawing tickets are increased,
wherein the consolation prize is reset to a consolation base amount after the consolation prize has been awarded to one of the players,
wherein the possible values are two digits ranging from 00 to 99,
wherein each player is awarded a predetermined cash prize based on a number of vouchers redeemed by each player,
wherein the predetermined cash prize is a function of the number of vouchers redeemed by each player in a week, wherein the voucher provided to one of the players is an electronic voucher if based on player tracking points, wherein the voucher provided to one of the players is an electronic voucher if based on an external triggering event.
